(19) United States
(12) Patent Application Publication
(10) Pub. No.: US 2024/0295731 A1
(43) Pub. Date: Sep. 5, 2024

(54) LISSAJOUS MICROSCANNER HAVING CENTRAL MIRROR MOUNT AND METHOD FOR PRODUCTION THEREOF

(71) Applicant: OQMENTED GMBH, Itzehoe (DE)

(72) Inventors: Ulrich HOFMANN, Itzehoe (DE); Thomas VON WANTOCH, Kiel (DE); Stephan MARAUSKA, Kaltenkirchen (DE); Oleg PETRAK, Itzehoe (DE); Marcel METSCHULAT, Itzehoe (DE); Leon POHL, Schwentinental (DE)

(21) Appl. No.: 18/573,499

(22) PCT Filed: Jun. 21, 2022
(86) PCT No.: PCT/EP2022/066828

§ 371 Date: Dec. 22, 2023

(30) Foreign Application Priority Data
Jun. 22, 2021 (DE) 10 2021 116 165.7

(51) Int. Cl. G02B 26/10; G02B 26/08

(52) U.S. Cl. CPC G02B 26/101; G02B 26/0858

(57) ABSTRACT

A microscanner has: a deflection element for deflecting an incident electromagnetic beam; a support structure; and a spring device comprising one or more springs, by means of which the deflection element is suspended on the support structure in an oscillating manner in such a way that it can simultaneously carry out a first rotational oscillation around a first oscillation axis and a second rotational oscillation around a second oscillation axis orthogonal thereto relative to the support structure, in order to be able to effectuate a Lissajous projection in an observation field by reflection of an electromagnetic beam incident on the deflection element during the simultaneous oscillations. The support structure has a spring support structure and the spring device has a number N of first springs, wherein N≥1 and each of the N first springs is attached to at least one assigned attachment point on the spring support structure, is coupled to the deflection element at at least one assigned coupling point, and extends between this attachment point and this coupling point. There are three points on the deflection element, which in its rest position define a Euclidean auxiliary plane and therein span a surface or straight-line section enclosed by the connecting straight line between the three points, on which each of the attachment points, or their respective perpendicular projection on the auxiliary plane, lies.

The present invention is in the field of microtechnically produced beam deflection systems and relates to a microscanner for generating a Lissajous projection into an observation field and a method for producing such a microscanner.

Microscanners, which are also referred to in the technical language in particular as “MEMS scanners”, “MEMS mirrors”, or “micromirrors”, or in English in particular as “micro-scanner” or “micro-scanning mirror” or “MEMS mirror”, are micro-electro-mechanical systems (MEMS) or more specifically micro-opto-electro-mechanical systems (MOEMS) from the class of micro-mirror actuators for dynamic modulation of electromagnetic radiation, such as visible light. Depending on the design, the modulating movement of an individual mirror can be translational or rotational around at least one axis. In the first case, a phase-shifting effect is achieved, and in the second case, the deflection of the incident electromagnetic radiation is achieved. We will also consider microscanners in which the modulating movement of an individual mirror is rotational. In microscanners, the modulation is generated via a single mirror, in contrast to mirror arrays, in which the modulation of incident light occurs via the interaction of multiple mirrors.

Microscanners may be used in particular to deflect electromagnetic radiation in order to modulate an electromagnetic beam incident thereon with respect to its direction by means of a deflection element (“mirror”). This can be used in particular to effectuate a Lissajous projection of the beam into an observation field or projection field. For example, imaging sensory objects can be achieved or display functionalities can be implemented. In addition, such microscanners can also be used to irradiate materials in an advantageous manner and thus also process them. Possible other applications are in the area of lighting or illuminating certain open or closed spaces or areas of space using electromagnetic radiation, for example in the context of headlight applications.

In many cases, microscanners consist of a mirror plate (deflection plate) that is suspended laterally on elastically stretchable springs. A distinction is made between single-axis mirrors, which are preferably only to be suspended to be movable around a single axis, from two-axis and multi-axis mirrors.

Both in the case of imaging sensors and in the case of a display function, a microscanner is used to deflect electromagnetic radiation such as a laser beam or a shaped beam from any other source of electromagnetic radiation at least two-dimensionally, for example horizontally and vertically, in order to thus scan or illuminate an object surface within an observation field. In particular, this can be done in such a way that the scanned laser beam sweeps over a rectangular area on a projection surface in the projection field. In these applications, microscanners having at least two-axis mirrors or single-axis mirrors connected in succession in the optical path are used. The wavelength range of the radiation to be deflected can in principle be selected from the entire spectrum from short-wave UV radiation, through the VIS range, NIR range, IR range, FIR range to long-wave terrestrial and radar radiation.

Microscanners are often manufactured using methods of silicon technology. Based on silicon wafer substrates, layer deposition, photolithography, and etching techniques are used to form microstructures in the silicon and thus implement microscanners having movable MEMS mirrors.

Electrostatic, electromagnetic, piezoelectric, thermal, and other actuator principles are typically used as drives. The mirror movement can in particular be quasi-static (=non-resonant) or resonant, the latter in particular in order to achieve greater oscillation amplitudes, greater deflections, and higher optical resolutions. In addition, in resonant operation, energy consumption can generally be minimized or advantages can be achieved, particularly in terms of stability, robustness, manufacturing yield, etc. Scan frequencies from 0 Hz (quasi-static) to over 100 kHz (resonant) are typical.

Although the microscanners according to the invention described here can in principle be used reasonably and successfully in many different areas, their application in the area of laser projection displays will be discussed in particular hereinafter.

In many known cases, microscanner-based laser projection displays are so-called raster scan displays, in which a first beam deflection axis is operated at high frequency in resonance (typically 15 kHz to 30 kHz) (fast axis) to generate the horizontal deflection and a second axis is operated quasi-statically at low frequency (typically 30 Hz to 60 Hz) to generate the vertical deflection. A fixed grid-like line pattern (trajectory) is typically reproduced 30 to 60 times per second.

A different approach is used in the so-called Lissajous microscanners, in particular also in Lissajous scan displays. There, both axes are usually operated in resonance and a scan path in the form of a Lissajous figure is created. In this way, large amplitudes can be achieved in both axes. The vertical deflection in particular can therefore be very much greater than with a raster scanner. Accordingly, with a Lissajous microscanner, in particular a Lissajous scan display, a significantly higher optical resolution can usually be achieved than with a raster scan display, especially in the vertical direction.

Various architectures known from the prior art for Lissajous microscanners, in particular for their micromirrors, including their suspension, are known in particular from the publications DE 102009058762 A1 or EP 2 514 211 B1 and U.S. Pat. No. 8,711,456 B2 and are described below with reference to FIGS. 1 to 4. These architectures share the feature that the mirror suspension is always formed exclusively by means of a plurality of springs, each of which extends between an outer edge of the plate-shaped mirror and a closed, fixed frame surrounding the mirror.

One or more of the following requirements are typically placed on a microscanner-based Lissajous laser beam deflection system:
high scanning frequencies, for example between a minimum of 10 kHz and a maximum of 80 kHz, in order in particular to be able to project as many lines per second as possible and to be able to implement high image repetition rates;
preferably, both beam deflection axes (oscillation axes) are not to differ too much in terms of their scanning frequencies and are therefore to represent two fast axes, in order in particular to achieve very favorable trajectories, good and very fast coverage of the projection area and, in the case of displays, to generate as few as possible or only slightly pronounced flickering artifacts for the observer. The terms “fast” and “slow” in relation to a particular (vibration) axis refer here to the vibration frequency with which the deflection element (mirror) of the microscanner oscillates around an associated axis during its operation. In particular, the terms are used relatively to distinguish a “faster” axis from a “slower” axis.
Large mirror diameters, in particular to be able to implement small spot sizes and high optical pixel resolution. Especially in conjunction with optical wave guides, large mirror diameters are of great advantage, so that a large so-called “eyebox” and low diffractive losses and as few artifacts as possible can be achieved;
large beam deflection angles, in particular to enable the highest possible pixel resolution and a large projection or observation field (field-of-view, FoV);
the smallest possible installation space or small chip size, in particular to enable the microscanner-based laser projector of electronic devices, for example smart glasses (e.g. augmented reality (AR) glasses), smartphones, or tablet computers, to be able to disappear nearly invisibly into the glasses' earpieces or into the housing of the smartphone or tablet, but at the same time also to enable low production costs;
minimal power consumption, in particular to ensure low heat generation from the end device and the longest possible battery life.

However, these are often opposing requirements, as the following examples show:
A microscanner which is reduced in its size in order to be able to better serve compactness requirements usually loses actuator area, thus driving force or torque and thus (pixel) resolution and performance (e.g., image field size, achievable image repetition rate).
A microscanner that is reduced in size usually loses the area available for accommodating spring suspensions. This increases the stress in the suspensions and reduces the mechanical deflection and thus also the optical resolution and performance.
A microscanner, the power consumption of which is reduced in favor of a longer functional life of a mobile device or an application running thereon, usually loses drive power or torque, and therefore resolution and performance.
A mirror plate that is enlarged for reasons of smaller spots and therefore higher optical resolution usually increases in mass and moment of inertia and therefore reduces the achievable dynamics and speed.
A mirror plate that is enlarged for reasons of higher optical resolution usually thus displays larger dynamic deformations, which increases the beam divergence and the spot size and partially reduces the resolution.
A spring suspension that is stiffened in favor of higher scanning speeds and higher trajectory repetition rates generally achieves smaller deflections and therefore reduces the achievable optical resolution.

Overall, the design of microscanners generally results in challenging optimization problems, the solution of which often requires taking into consideration not only one or more of the above-mentioned parameters, but also many other properties and boundary conditions. Such additional properties and boundary conditions can in particular affect the manufacturability, manufacturing costs, yield, electronic controllability, reproducibility, available modulation bandwidth of laser sources and drivers, and much more.

The present invention is based on the object of providing an improved, at least two-axis, in particular resonantly operable, microscanner for the Lissajous figure-shaped scanning of an observation field or (equivalently) projection field, which enables an improvement with regard to at least one of the above-mentioned problems. In addition, a production method suitable for producing such a microscanner is to be specified.

This object is achieved according to the teaching of the independent claims. Various embodiments and developments of the invention are the subject matter of the dependent claims.

A first aspect of the invention is directed to a microscanner for projecting electromagnetic radiation onto an observation field (projection field), wherein the microscanner comprises: (i) a deflection element, in particular a mirror, for deflecting an incident electromagnetic beam; (ii), a support structure; and (iii) a spring device comprising one or more springs, by means of which, the deflection element is suspended on the support structure in an oscillating manner in such a way that it can simultaneously carry out a first rotational oscillation around a first oscillation axis and a second rotational oscillation around a second oscillation axis orthogonal thereto relative to the support structure, in order to be able to effectuate a Lissajous projection in an observation field by deflection of an electromagnetic beam incident on the deflection element during the simultaneous oscillations.

The support structure has a spring support structure and the spring device has a number N of first springs, wherein N≥1 and each of the N first springs is attached to at least one assigned attachment point on the spring support structure, is coupled to the deflection element at at least one assigned coupling point, and extends between this attachment point and this coupling point. There are three points on the deflection element, which in its rest position define a Euclidean, in particular virtual auxiliary plane and in the auxiliary plane span a surface or straight line section enclosed by the connecting straight line between the three points, on which each of these attachment points, or their respective perpendicular projection on the auxiliary plane, lies (The connecting straight lines themselves count here as part of the surface or straight line section. In addition, there do not necessarily have to be exactly three points that meet the above-mentioned condition. Rather, there can be any, in particular even an infinite number of point triples made up of such points).

In particular, a “spring” as defined in the invention is understood as an elastic body, in particular a machine element, for absorbing and storing mechanical (potential) energy, which deliberately deforms under load in the load range below an elasticity limit and, when released, resumes its original form. The load can be produced in particular by means of torsion or bending. Accordingly, a spring can in particular be a bending spring or a torsion spring.

A “deflection element” as defined in the invention is understood in particular as a body which has a reflective surface (mirror surface) that is smooth enough that reflected electromagnetic radiation, such as visible light, retains its parallelism under the law of reflection and a picture can thus result.

The roughness of the mirror surface has to be less than approximately half the wavelength of the electromagnetic radiation for this purpose. The deflection element can in particular be designed as a mirror plate having at least one mirror surface or can include such a mirror plate. In particular, the mirror surface itself can consist of a different material, for example of a metal, which may in particular be deposited, than the other body of the deflection element.

For the purpose of the invention, an “attachment point” of a spring means in particular a point at or in the support structure at which the spring is fastened on the support structure or, in the case of a spring being formed in one piece with the support structure or a part thereof, merges into it, and which, in the case of oscillations of the deflection element, forms a fixed point of the spring movement which occurs in the process. The spring can in particular also be attached to a plurality of connected or separate attachment points on the spring support structure.

In the meaning of the invention, a “coupling point” of a spring is to be understood as meaning, in particular, a point on or in the spring from which it is fastened directly, or indirectly via one or more intermediate bodies, to the deflection element or, in the case that it is formed in one piece with the deflection element or part thereof, merges into it. The spring can in particular also be coupled to the deflection element from a plurality of connected or separate coupling points. The terms “coupling”, “couple”, “coupled” and variations thereof refer accordingly to direct or indirect, in particular mechanical, force coupling between at least two bodies, such as the deflection element or the support structure on the one hand and a spring on the other.

An “oscillation axis” or “axis” as defined in the invention is to be understood in particular as an axis of rotation of a rotational movement. It is a straight line that defines or describes a rotation or turn.

A “Lissajous projection” as defined in the invention is to be understood in particular as scanning of an observation field with the aid of electromagnetic radiation, which is effectuated by at least two orthogonal oscillations, which are at least essentially sinusoidal, of a deflection element that deflects the radiation into the field of observation.

A Euclidean “auxiliary level” means, according to the usual use of language in mathematics, in particular a Euclidean level in three-dimensional space, which does not have to be materially implemented (at least not necessarily) (for example by corresponding flat surfaces of a real body), but is usually defined only as an abstract (virtual) mathematical aid, in particular for solving or describing a geometric problem or condition.

As possibly used herein, the terms “comprises,” “contains,” “involves,” “includes,” “has,” “having,” or any other variant thereof are intended to cover non-exclusive inclusion. For example, a method or a device that comprises or has a list of elements is not necessarily restricted to these elements, but may involve other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as possibly used herein, are defined in the meaning of “one or more”. The terms “another” and “a further” and any other variant thereof are to be understood to mean “at least one other”.

The term “plurality” as used herein is to be understood to mean “two or more”.

In the meaning of the invention, “configured” or “configuration” or modifications of these terms is to be understood as meaning that the corresponding device is already configured or adjustable—i.e., configurable—to fulfill a specific function. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

In the microscanner according to the first aspect, the (first) springs, on which the deflection element, which in particular is designed as a mirror plate or can have one, is suspended, do not extend from the deflection element, unlike the solutions known from the prior art, directed outwards towards a chip frame. Instead, they extend directed inwards towards their respective, correspondingly positioned attachment point on the spring support element, which thus provides a central, but not necessarily centered, suspension of the first springs and thus indirectly also of the deflection element.

This enables in particular a lower mass moment of inertia of the oscillating parts, i.e., the deflection element in combination with the springs, and as a result large scanning angles and/or high scanning frequencies for both axes, a compact design and, as a result, usually also lower manufacturing costs and/or lower spring stress due to shorter stroke. In addition, due to the lesser maximum deflections required, the inwardly directed (first) springs make it possible to reduce or even avoid oscillation movements that lead into non-linear spring operating ranges with regard to the spring bending or torsion, which is advantageous for the component performance.

Areas of application for such microscanners can in particular be: augmented and virtual reality glasses displays, head-up displays, pico projectors, cinema projectors, laser TV, 3D cameras, LIDAR sensors, gesture recognition systems, hyperspectral cameras, photoresist exposers, laser material processing systems, radar scanners, OCT scanners (OCT=optical coherence tomography).

Preferred embodiments of the microscanner according to the first aspect are described hereinafter, which in each case, unless expressly excluded or mutually exclusive, can be combined as desired with one another.

In some embodiments, the deflection element has rotational symmetry with respect to a (first) axis of symmetry in its rest position and is arranged such that the (first) axis of symmetry extends through the spatial area spanned by the spring support structure. The rotational symmetry can in particular be n-fold (n=2, 3, 4, . . . ) or even circular symmetry. In particular, the spring support structure as a whole, a section of the spring support structure containing the attachment points of the first springs, or the arrangement of the attachment points of the first springs can also have rotational symmetry with respect to a second axis of symmetry and can be arranged so that the first and second axes of symmetry coincide.

All of these embodiments share the feature that they have, at least essentially, a central suspension of the deflection element on a centrally arranged spring support structure, which in particular promotes a correspondingly rotationally symmetrical mirror movement. In particular, it is possible to choose the first springs of the same length or even identical overall or in pairs and thus to enable a suspension that is approximately symmetrical at least with respect to one direction and thus symmetrical movement. This can also result in advantages in terms of a particularly simple structure due to the symmetry and a correspondingly simplified adjustment.

The term “spanned space” (or linguistic modifications thereof) is to be understood to mean that the “spatial area spanned” by the spring support structure includes all spatial points that lie on any path spanned by two points as a straight-line connection in between, wherein these spanning points are each located on the surface or inside the spring support structure itself. All of these points “spanning” the spatial area as a whole are also included in the spanned spatial area. For example, the spatial area spanned by a cylindrical tube includes, in addition to the spatial area occupied by the material tube itself, also the cavity enclosed by the tubular cylinder wall in the interior of the tube.

In some embodiments, the N first springs are each attached to the support structure exclusively on the spring support structure and the deflection element is suspended exclusively on these first springs. In this way, particularly small constructions can be achieved. Since exclusively the first springs are provided for the suspension of the deflection element here, a particularly low mass moment of inertia and/or, as a result, high scanning speeds and large scanning angles can moreover be achieved. The above-mentioned advantage that the vibrations of the deflection element are less influenced by potential nonlinearities of the springs, which typically occur in particular with large deflections, can also be used advantageously here.

In some embodiments, the deflection element has a deflection plate (micromirror, mirror plate) having a recess formed therein. Due to the recess, the mass moment of inertia of the deflection plate can be further reduced in this way. Accordingly, the springs can be designed to be lighter or slimmer, which also results in advantages in terms of weight, structural size, and scanning speed. In this regard, constructions for the deflection plate having rotational symmetry (such as n-fold or circular symmetry) are advantageous in particular. In particular, the deflection plate can have a rotationally symmetrical ring shape, such as a circular ring shape, in which the ring interior lying outside the deflection element body forms the recess.

In some of these embodiments, at least one, or in particular all, of the first springs extend at least in some sections within the recess. This permits particularly space-saving implementations of the microscanner. In particular, particularly flat implementations can thus also be achieved, especially when all springs extend within the recess and the deflecting plate and springs are essentially in a common plane (more precisely, in a “plate-shaped” spatial area of low thickness).

In some of the embodiments having a recess in the deflection plate, the microscanner furthermore has optics for shaping incident electromagnetic radiation into an emerging electromagnetic beam directed onto the deflection element, the radial intensity profile of which occurs when it is incident on the deflection element in such a way that a radial intensity maximum of the beam surrounds the recess on two opposite sides of the recess, in particular annularly.

The optics can in particular have an axicon. Axicons are conical lenses that produce an annular radial beam profile. In particular, ring mirrors can be used particularly advantageously for laser projection tasks if an incident laser beam having a round, in particular circular, beam profile is previously converted into an annular beam with the aid of a refracting, diffracting, or reflecting axicon, which is then incident on the annular mirror plate as the annular beam and is deflected thereby biaxially as an annular beam. If focusing optics are selected in conjunction with the axicon and the ring mirror at the same time so that the annular rays meet one another in a focus, then interference between the rays can even occur, which in the case of Bessel rays advantageously enable small focus diameters and a very high achievable optical resolution of the projecting system.

In some embodiments, at least one of the N first springs is shaped, in particular in an arc shape, such that in its rest position its effective spring length between the deflection element and the spring support structure is greater than the minimum occurring distance between one, in particular each, of its coupling points on the deflection element on the one hand and one, in particular each, of their attachment points on the spring support structure on the other hand. In particular, multi-leg suspensions having large spring travel (stroke) and thus large deflections and thus in turn large observation fields can be achieved. In particular, the arrangement of the first springs can have a spiral shape (in particular similar to the spiral shape of a spiral galaxy).

In some embodiments, the spring device has exactly N=2 first springs, which together form a two-leg suspension of the deflection element on the spring support structure. In particular, the arrangement of the two springs can again have rotational symmetry. In addition to the particularly simple structure, the use of exactly two springs has the advantage that the exact positions and scanning frequencies (oscillation frequencies) of the first and second oscillation axes can be predetermined particularly easily and precisely here. In addition, right-angled observation fields can be achieved particularly well with symmetrical two-leg suspensions, in particular with symmetrical two-leg suspensions.

In some alternative embodiments, however, the spring device has N=4 first springs, wherein these four first springs together form a cross-shaped, in particular orthogonal, suspension of the deflection element on the spring support structure. Here too, a relatively simple structure and easy and precise determinability of the positions and scanning frequencies of the first and second oscillation axes are advantageous.

In some variants of these embodiments, any two of the (first) springs arranged in a cross shape, which can in particular be two of the four first springs that are opposite to one another within the framework of the cross-shaped suspension, form a respective pair of springs made up of springs of the same spring stiffness, while the respective spring stiffnesses differ for the first springs of the two pairs of springs. This makes it particularly easy to implement different scanning frequencies for the first oscillation axis on the one hand and the second oscillation axis on the other hand, in particular with rotationally symmetrical suspension.

In some embodiments, the support structure furthermore has a frame structure which surrounds the deflection element at least on two sides and is fixed with respect to the first and second rotational oscillations of the deflection element, on which the deflection element is additionally suspended by means of a number M of second springs, wherein M≥1. The deflection element is thus suspended on the one hand by means of the N first springs on the spring support structure and on the other hand by means of the M second springs on the frame structure. M can in particular be equal to N (M=N).

These embodiments can in particular facilitate further differentiation of the different effective spring stiffnesses for the first and second oscillation axes and thus of their respective scanning frequency and the maintenance thereof during the scanning process. By combining the first and second springs, it is possible in particular to increase the effective overall stiffness of the spring suspension with respect to the affected oscillation axis while maintaining operation in the linear range and thus in particular to achieve even higher scanning frequencies on this oscillation axis. It is also particularly advantageously possible to select the stiffness of the second springs to be lower than that of the first springs. In particular, it is necessary to maintain a certain frequency interval between the scanning frequencies of the two oscillation axes in order to be able to implement a rectangular illumination, i.e., an, in particular approximately homogeneous, illumination of rectangular projection fields seen in the cross section to the optical axis.

Despite the additional frame structure and the second springs, particularly small constructions can thus be implemented since the second springs can be made shorter and/or less rigid than in the known solutions from the prior art.

In some of these embodiments, the suspension of the deflection element on the spring support structure by means of the N first springs defines the first oscillation axis and the suspension of the deflection element by means of the M second springs on the frame structure defines the second oscillation axis, at least predominantly in each case. By appropriately selecting the respective spring properties of the first springs on the one hand and the second springs on the other hand, the spring stiffnesses and thus the scanning frequencies for each of the two axes can be set or defined particularly easily. In addition, axis-specific drives having one or more separate assigned actuators per axis can be implemented particularly easily. The same applies to sensors for determining the position of the deflection element.

In some embodiments, N≥2 applies and the deflection element extends between the respective coupling points of the N first springs, so that it at least partially bridges the spring support structure. The coupling points can in particular also be end points of the respective springs. In this way, particularly compact constructions of the microscanner and a particularly favorable (i.e., large) ratio of available mirror area (for reflecting electromagnetic radiation) to the total area (in particular chip area) of the microscanner can be achieved in particular. The deflection element can in particular also be formed without a recess, since it is not necessary to accommodate the springs in the recess in order to achieve a compact construction.

In some of these embodiments, the deflection element has a substrate designed as a deflection plate for deflecting the incident electromagnetic beam, which is connected by means of at least one bond connection to one or more of the first springs or to an intermediate body arranged between one or more of the first springs on the one hand and the deflection plate on the other hand. This has the advantage that during production, the deflection plate is manufactured separately from the substrate used to produce the first springs and possibly the intermediate body and can only subsequently be coupled to the spring suspension by means of the bond connection. The bond connection can in particular be: (i) an anodically produced bond connection, which is particularly suitable if glass and silicon can be connected to one another; (ii) a eutectic bond connection (such as Au—Au); (iii) a connection produced by means of thermocompression; (iv) an immediate (direct) bond connection, in particular a laser-assisted direct bond connection; or (v) a glass frit bond connection, in particular for large mirror diameters.

In some of the above-mentioned embodiments having a frame structure and a deflection element bridging the spring support structure, the spring device furthermore has a number K of third springs, wherein K≥1. Each third spring is coupled on the one hand to the respective coupling point of an assigned first spring or possibly the intermediate body and on the other hand to the frame structure. In particular, the cases K=M and/or K=N are possible. The suspension of the deflection element on the frame structure is thus achieved on the one hand by the second springs and on the other hand by the third springs. In particular, an even further increase in the effective spring stiffness can be achieved for the first and second oscillation axes, in particular for operation in the Hookian (linear) range. These embodiments also still further expand the available design freedom and configuration options when designing the microscanner due to the additional degrees of freedom (e.g., number, type, and position of the additional third springs). In addition, variants are possible in which the second springs are omitted and in particular those in which exclusively the first and third springs form the spring device.

In some embodiments, the microscanner further comprises an encapsulation, by means of which at least the deflection element and the springs of the spring device are encapsulated hermetically sealed in such a way that the deflection element in the encapsulation is suspended on the spring device in a manner capable of carrying out the oscillations. The encapsulation has a capsule section bridging the deflection element, through which the radiation to be deflected can be radiated into the spatial area encapsulated by the encapsulation and, after it is deflected at the deflection element, can be emitted therefrom again. The encapsulation or the capsule section can in particular consist of or contain a glass material which is at least predominantly, preferably largely, transparent to electromagnetic radiation in a spectral range relevant to the use of the microscanner.

The use of such an encapsulation makes it possible in particular to reduce the pressure in the hermetically sealed encapsulated spatial area, in particular to evacuate this spatial area, in order to reduce or even largely eliminate gas friction losses, in particular air friction losses, or other disturbances to the oscillations of the deflection element. This is particularly advantageous in the case of using the microscanner for Lissajous display applications if the deflection element and its spring suspension are not operated in ambient air, but at reduced pressure, in particular in vacuum, because this avoids friction losses due to the air damping in a very efficient manner and as a result the microscanner can, for example, achieve vibration amplitudes that are up to 100 times greater than in air under atmospheric pressure. Accordingly, the achievable optical resolution can also be increased correspondingly, for example up to 100 times, in one or each of the first and second oscillation axes.

In some of these embodiments, the capsule section has a dome-shaped (cupola-shaped), planar, or U-shaped design, which is rectangular in cross section. The dome-shaped design has the advantage in particular that incident and exiting electromagnetic beams, in particular laser beams, are hardly deflected by the cabling. To the extent that incident rays are reflected on the dome-shaped capsule section, this regularly occurs in a different direction than the direction of the exiting ray reflected on the deflection element, so that undesirable interactions or superpositions of the rays can be effectively avoided here. The planar design and the U-shaped design which is rectangular in cross section, on the other hand, are each characterized by their particularly easy producibility and handling when manufacturing the microscanner. The U-shaped design which is rectangular in cross section can also offer the advantage that any otherwise additionally required intermediate layers (spacer layers) in the substructure of the encapsulation for the formation of a spatial area enclosed by the encapsulation that is sufficiently large for the movement of the deflection element can be avoided or reduced in their number or thickness.

In some of these embodiments having encapsulation, the capsule section is mounted on a first layer stack which comprises a first layer sequence which corresponds to a second layer sequence of a second layer stack in terms of the order, the material, and/or the thickness of the individual layers of the first layer sequence, from which the combination of the deflection element, the spring device (at least the first springs), and the spring support structure is manufactured. This allows a particularly efficient production process, since the first layer stack and the second layer stack can be manufactured as sections of a single common layer stack and can only receive their respective shape and thus their respective functionality as part of the structuring of the common layer stack.

In some embodiments, the quality factor, i.e., Q-factor, of the microscanner with respect to at least one of the two oscillations is at least 1000. This can be achieved in particular in connection with embodiments having an encapsulation, in particular with a gas pressure reduced in relation to atmospheric pressure or vacuum within the interior encapsulated by the encapsulation. This makes it possible to achieve a further performance improvement in particular.

In some embodiments, the microscanner furthermore comprises: (i) a carrier substrate that supports the spring support structure; and (ii) an actuator for driving the first oscillation and/or the second oscillation of the deflection element. The actuator is mechanically coupled to the carrier substrate in order to act on it mechanically during operation of the microscanner and thereby indirectly effectuate a driving effect on the deflection element for driving its first and/or second oscillations, at least via the spring support structure and the first springs. These embodiments make it possible in particular to dispense with oscillation axis-specific actuators for driving the oscillations of the microscanner and thus to design the oscillatory components or sections of the microscanner (deflection element, springs) as solely passive components, which then in particular do not require any power or signal supply.

In some of these embodiments, the actuator is arranged adjacent to a cavity in the carrier substrate or another substrate connected to the actuator, in particular a carrier or bottom substrate of the microscanner, so that during its operation it can execute a movement extending into the cavity at least in some sections. In this way, particularly space-saving, compact constructions can be implemented while maintaining a high effective drive power of the actuator with regard to the deflection element and large possible deflections.

In some of the above-mentioned embodiments having an actuator, this is also designed as a sensor device for sensory detection of the current position of the deflection element or as a part of such a sensor device. In particular, the actuator can have a piezo actuator, which is also used as an electrode of a sensor arrangement based on electrical capacitance measurement.

In some embodiments, one or more actuators or sensors are provided on the spring support structure or the spring device, which are connected to one or more signal or power supply lines, which overall extend at least in some sections through one or more openings (channels) provided in the spring support structure.

In some embodiments, the microscanner is configured in such a way that for the frequency ratio of the resonance frequency f₁ with respect to the faster of the two oscillation axes to the resonance frequency f₂ with respect to the slower of the two oscillation axes, the following applies: f₁/f₂=F+v, wherein F is a natural number (F=1,2,3, . . . ) and the following applies to the detuning v: v=(f₁−f₂)/f₂ with (f₁−f₂)<200 Hz, wherein v is not an integer.

In some embodiments, the microscanner comprises an actuator system having one or more actuators for driving the first and second oscillations, wherein the actuator system is configured so that it can set the deflection element into a double-resonant oscillation with respect to the first and second oscillation axes. The actuator system can in particular have or consist of one or more actuators described in preceding embodiments.

In some of these embodiments, the actuator system is configured in such a way that it can set the deflection element into simultaneous oscillations with respect to the first and second oscillation axes in such a way that for the frequency ratio of the oscillation frequency f₁ with respect to the faster of the two oscillation axes to the oscillation frequency f₂ with respect to the slower of the two oscillation axes, the following applies: f₁/f₂=F+v, wherein F is a natural number (F=1,2,3, . . . ) and the following applies to the detuning v: v=(f₁−f₂)/f₂ with (f₁−f₂)<200 Hz, wherein v is not an integer. This results here in a frequency ratio f₁/f₂ close to 1, 2, 3, or 4, etc.

The detuning v can be achieved in the above-mentioned cases with detuning v in particular in such a way that only one of the two oscillation frequencies or both differs or differ from the respective resonance frequency for the associated oscillation axis. The detuning v in relation to an integer frequency ratio plays a major role here, because this detuning of the frequency determines how quickly the Lissajous trajectory continues to move spatially. With an integer ratio, the detuning is zero and the trajectory is stationary and constantly reproduces itself in this form. At a noninteger detuning v>0, in contrast, the trajectory begins to travel, specifically within a certain interval the faster the greater the detuning v is in relation to the integer ratio. The speed of progress at which the trajectory continues to move can advantageously be chosen so that a specific trajectory repetition rate (complete phase passages/time), for example from the frequency range 30 Hz to 100 Hz is established, with which the trajectory reproduces or reproduces under ideal undisturbed conditions. (For explanation: Exact reproduction is often not possible, especially when using phase-locked loops or other control loops. Nevertheless, the advantages of a well-chosen detuning and an accompanying favorable speed of progress of the trajectory remain). On the basis of a detuning v selected in this way, in particular an improved, i.e., increased line density, at least on average over time, can also be achieved.

A second aspect of the invention relates to a method for producing a microscanner according to the first aspect. The method has the following steps or processes: (i) providing a plate-shaped substrate, in particular a semiconductor substrate, having two opposing main surfaces; (ii) structuring the substrate from a first of the main surfaces to at least partially form the deflection element, the support structure, and the spring device; (iii) selectively, at least partially, exposing the deflection element and the spring device formed by means of the structuring from the other main surface; and (iv) fastening the microscanner assembly resulting from the exposure to a carrier substrate.

The structuring and exposing can, particularly in the case of a semiconductor substrate, be carried out using known MEMS manufacturing technologies, in particular semiconductor chip manufacturing technologies, using (photo)lithography in conjunction with a suitable etching method.

In some embodiments, the method can furthermore comprise at least one of the following steps or processes: (v) applying a reflection layer to a surface section intended to form the deflection element on a main side of the substrate, in particular on the first main side; (vi) hermetically encapsulating the microscanner arrangement fastened to the carrier substrate by means of encapsulation; (vii) bonding at least two adjacent substrates within a layer stack used to construct the microscanner by means of an anodic, eutectic, or direct bonding method or a thermocompression method; (viii) creating one or more actuators or sensors on the spring support structure or the spring device and creating one or more signal or power supply lines, which overall extend at least in some sections through one or more openings provided in the spring support structure and to which the actuators or sensors are connected. The sequence of processes (v) to (viii) specified here is not to be understood as a mandatory actual process sequence. Rather, the individual processes, if provided, can be implemented in a different order. For example, it is expedient to execute process (v) before process (i) and process (viii) before process (vi).

Further advantages, features, and possible applications of the present invention result from the following more detailed description in conjunction with the figures.

### In the Figures:

FIG. 1 schematically shows a top view of a two-axis, gimbal-suspended (i.e., with gimbal) micromirror having comb drives according to a microscanner architecture known from EP 2 514 211 B1;

FIG. 2 schematically shows a top view of a two-axis, gimballess-suspended micromirror according to a first microscanner architecture known from U.S. Pat. No. 8,711,456 B2;

FIG. 3 schematically shows a top view of a further two-axis, gimballess-suspended micromirror according to a second microscanner architecture known from U.S. Pat. No. 8,711,456 B2;

FIG. 4 schematically shows a top view of a still further two-axis, gimballess-suspended micromirror according to a third microscanner architecture known from U.S. Pat. No. 8,711,456 B2;

FIG. 5 schematically shows a microscanner according to a first embodiment of the invention;

FIG. 5A schematically shows a variant of the microscanner from FIG. 5, in which in particular the first springs do not extend along the auxiliary plane;

FIG. 6 shows a microscanner according to a further embodiment of the invention, in which in particular a single first spring is provided;

FIG. 7 shows a microscanner according to a further embodiment of the invention, in which in particular multiple first springs having an increased spring length and an applied actuator are provided;

FIG. 8 shows a microscanner according to a further embodiment of the invention, in which in particular a three-leg suspension made of first springs in a spiral shape is provided;

FIG. 9 shows a microscanner according to a further embodiment of the invention, in which in particular a two-leg suspension made of first springs in a spiral shape is provided;

FIG. 10 shows a microscanner according to a further embodiment of the invention, in which in particular two crossed pairs of springs made up of first springs are provided, wherein the spring stiffnesses of the two pairs of springs differ;

FIG. 11 shows a microscanner according to a further embodiment of the invention, in which in particular an outer frame and second springs extending between the frame and the deflection element are additionally provided;

FIG. 12 shows a microscanner according to a further embodiment of the invention, in which in particular the first springs at least predominantly define the spring stiffness for a first oscillation axis and the second springs at least predominantly define the spring stiffness for a second, orthogonal oscillation axis;

FIG. 13 shows a microscanner according to a further embodiment of the invention, in which the deflection element is designed as a separate substrate bridging the first springs;

FIG. 13A shows the microscanner from FIG. 13 at a time during its operation;

FIG. 14 shows a microscanner according to a further embodiment of the invention, in which in particular a further outer frame and third springs extending between this further frame and the deflection element bridging the first springs are additionally provided;

FIG. 14A shows the microscanner from FIG. 14 at a time during its operation;

FIG. 15 shows a microscanner according to a further embodiment of the invention, in which in particular an encapsulation formed by means of a cupola-shaped capsule section is provided;

FIG. 16 shows a microscanner according to a further embodiment of the invention, in which in particular one or more cavities are provided in the carrier substrate to enlarge the spatial area available for the oscillations of the deflection element;

FIG. 17 shows a microscanner according to a further embodiment of the invention, in which, in particular to further increase the spatial area available for the oscillations of the deflection element, an additional support structure is provided as a spacer in the layer structure supporting the capsule section;

FIG. 18 shows a microscanner according to a further embodiment of the invention, in which in particular an encapsulation formed by means of a planar capsule section is provided;

FIGS. 19 to 23 each show a microscanner according to further embodiments of the invention, in which in particular an encapsulation formed by means of a capsule section with a U-shaped cross section and a planar cover plate is provided;

FIG. 24 shows a microscanner according to a further embodiment of the invention, in which an actuator fastened on a further substrate for driving the microscanner and a cavity adjacent to the actuator are provided in the further substrate, in particular on the main side of the carrier substrate facing away from the deflection element;

FIG. 25 shows a microscanner according to a further embodiment of the invention, in which an actuator fastened on a further substrate for driving the microscanner and a cavity adjacent to the actuator are provided in the carrier substrate, in particular on the main side of the carrier substrate facing away from the deflection element;

FIG. 26 shows a microscanner according to a further embodiment of the invention, in which an actuator fastened on a further substrate for driving the microscanner and a cavity adjacent to the actuator are provided in the carrier substrate, in particular on the main side of the carrier substrate facing away from the deflection element, wherein the cavity extends in some sections over the end of the actuator;

FIG. 27 shows a microscanner according to a further embodiment of the invention, in which in particular one or more actuators are provided within the spatial area encapsulated by a capsule section;

FIG. 28 shows a microscanner according to a further embodiment of the invention, in which the spring support structure also represents a drive device of the microscanner;

FIG. 29 shows a microscanner according to a further embodiment of the invention, in which in particular optics for beam splitting into a beam with an annular intensity profile are provided;

FIG. 30 shows a first embodiment of a method according to the invention for producing a microscanner; and

FIG. 31 shows a second embodiment of a method according to the invention for producing a microscanner having electrical connections for electrical components, in particular actuators or sensors.

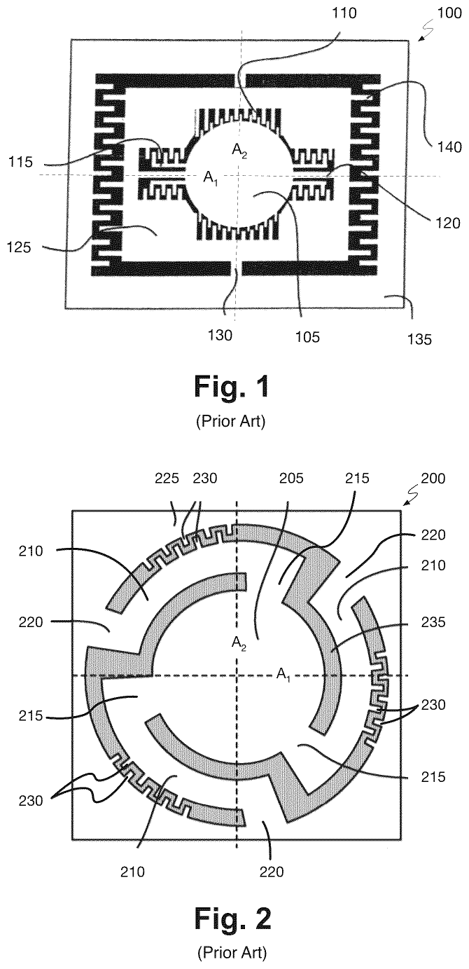

First of all, with reference to FIGS. 1 to 4, various microscanner architectures known from the prior art will now be briefly described with regard to their mirror suspension in order to provide a brief overview of a technical starting point from which the present invention proceeds.

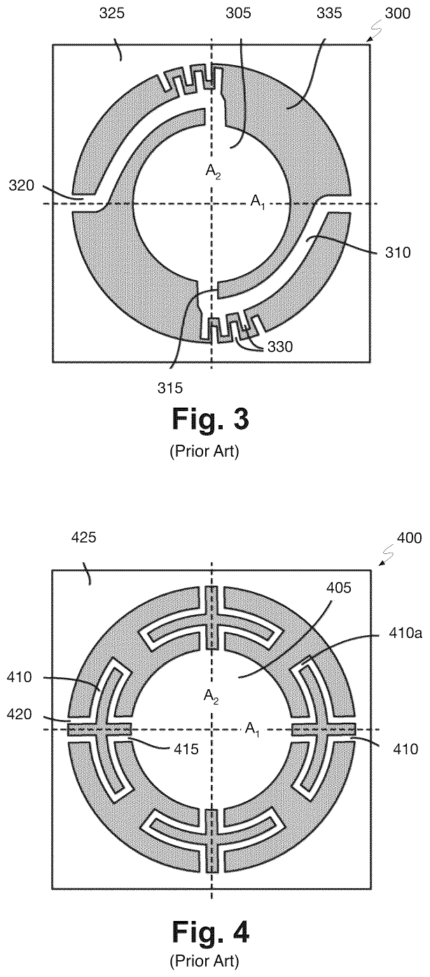

FIG. 1 shows a schematic top view of a microscanner architecture 100 known from EP 2 514 211 B1 having a two-axis (orthogonal oscillation axes A₁ and A₂), gimbal-suspended micromirror 105 (mirror plate). Electrostatic comb drives 110 remote from the axis and comb drives 115 close to the axis are also shown, which can also be used as sensor electrodes. The mirror plate 105 is suspended via internal torsion springs 120 in a movable frame 125, which is suspended in a fixed chip frame 135 by external torsion springs 130. The frame 125 can be caused to resonate by electrostatic comb drives 140, wherein comb electrodes that are also present near the axis for driving or sensor purposes of the movable frame 125 have been omitted for the sake of clarity. The oscillation axes A₁ and A₂ shown were added to the figure taken from EP 2 514 211 B1 (cf. FIG. 3 there) for better illustration and the reference numbers were adapted.

In FIG. 2, another microscanner architecture 200, known from U.S. Pat. No. 8,711,456 B2, is illustrated in a schematic top view, which shows a variant of the so-called “MiniFaros” type for a micromirror. The suspension of the mirror plate 205 is implemented in the form of a three-leg suspension by three bow springs 210, which are each connected at one of their respective ends 215 to the mirror plate 205 and at their respective other end 220 to the torsion-resistant, solid chip frame 225. In addition, each of the springs 210 is attached at a position rotated by 120° in relation to a corresponding position of the adjacent springs around the center of the mirror plate 205. Comb drives 230 are provided to drive the mirror movement and act on the springs 210 to deflect them. There are free spaces 235 between the springs and the chip frame 225 and the mirror plate 205, which allow the springs 210 to oscillate. To better illustrate the figure taken from U.S. Pat. No. 8,711,456 B2 (cf. FIG. 2 there), the reference numbers in FIG. 2 have been adapted and supplemented.

In FIG. 3, a further microscanner architecture 300, known from U.S. Pat. No. 8,711,456 B2, is illustrated in a schematic top view, which shows a further variant of the so-called “MiniFaros” type for a micromirror. The suspension of the mirror plate 305 is implemented in the form of a two-leg suspension by two bow springs 310, which are each connected at one of their respective ends 315 to the mirror plate 305 and at their respective other end 320 to the torsion-resistant, solid chip frame 325. In addition, each of the springs 310 is attached at a position rotated 180° from the corresponding position of the other spring 310 around the center of the mirror plate 305. Comb drives 330 are provided to drive the mirror movement and act on the springs 210 to deflect them. There are free spaces 335 between the springs 310 and the chip frame 325 and the mirror plate 305, which allow the springs 310 to oscillate. To better illustrate the figure taken from U.S. Pat. No. 8,711,456 B2 (cf. FIG. 3 there), the reference numbers in FIG. 3 have been adapted and supplemented.

In FIG. 4, a further microscanner architecture 400, known from U.S. Pat. No. 8,711,456 B2, is illustrated in a schematic top view, which shows a variant of the so-called “KOLA” type for a micromirror. The suspension of the mirror plate 405 is implemented in the form of a two-leg suspension by multiple, in the example four, bow springs 410, which are each connected at one of their respective ends 415 to the mirror plate 405 and at their respective other end 420 to the torsion-resistant, solid chip frame 425. In addition, each of the springs 410 is attached at a position rotated by 90° in relation to a corresponding position of the adjacent springs around the center of the mirror plate 405. To better illustrate the figure taken from U.S. Pat. No. 8,711,456 B2 (cf. FIG. 4 there), the reference numbers have been adapted and supplemented.

All of these previously known microscanner architectures 100 to 400 share the feature that the suspension of the respective micromirror plate 105, 205, 305, or 405 is carried out exclusively from the outside by springs 110, 210, 310, or 410 extending between an external, torsion-resistant chip frame 125, 225, 325, or 425 and the micromirror plate 105, 205, 305, or 405 respectively. Therefore, in none of these previously known microscanner architectures are there three points on the deflection element 105, 205, 305, or 405, which in its rest position define a Euclidean auxiliary plane and in the auxiliary plane span a surface or straight line section enclosed by the connecting line between the three points, on which each of the attachment points (e.g., 215, 315, or 415) of the springs, or its respective perpendicular projection onto the auxiliary plane, lies.

Consequently, the space or area requirement of the microscanner 100, 200, 300, or 400 in the mirror plane is significantly higher than the space or area requirement for the respective micromirror plate 105, 205, 305, or 405 itself. In addition, with medium and larger mirror diameters at the outside of the mirror plate, the springs have to carry out very large amplitudes out of the chip plane, which requires high stress values in the suspension in order to achieve the performance goals mentioned and therefore can easily result in overstressing of the material, in particular of the spring material.

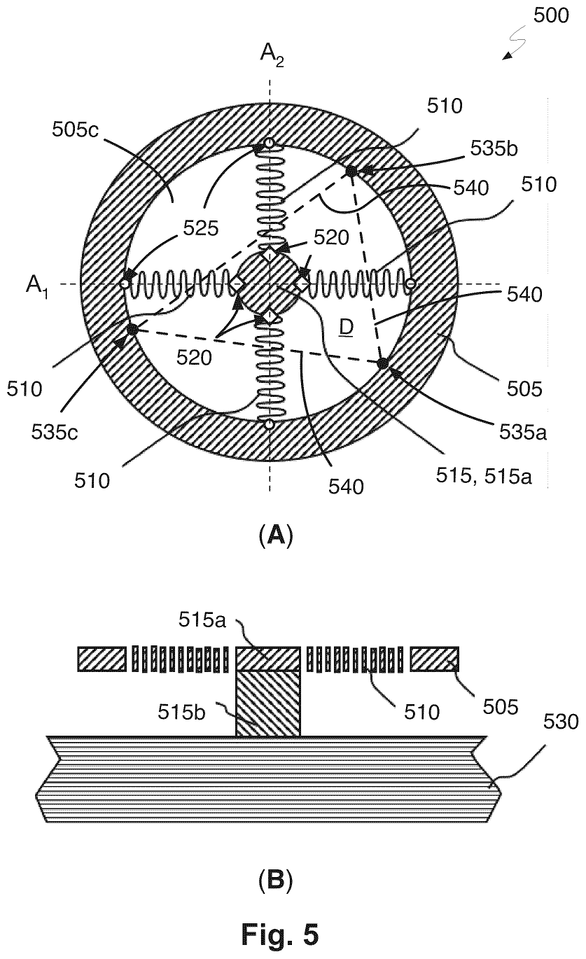

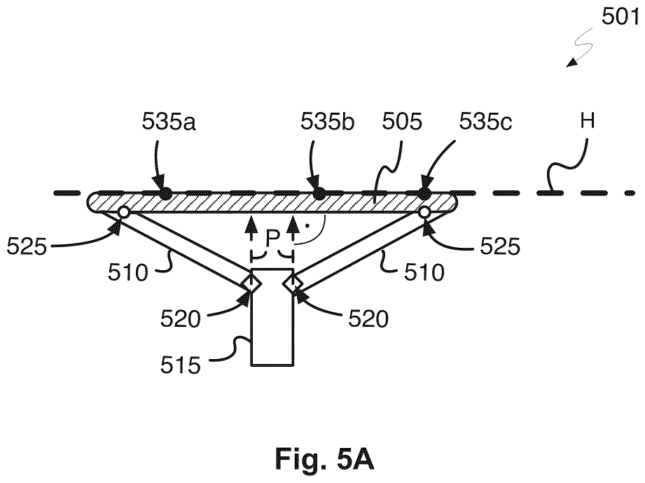

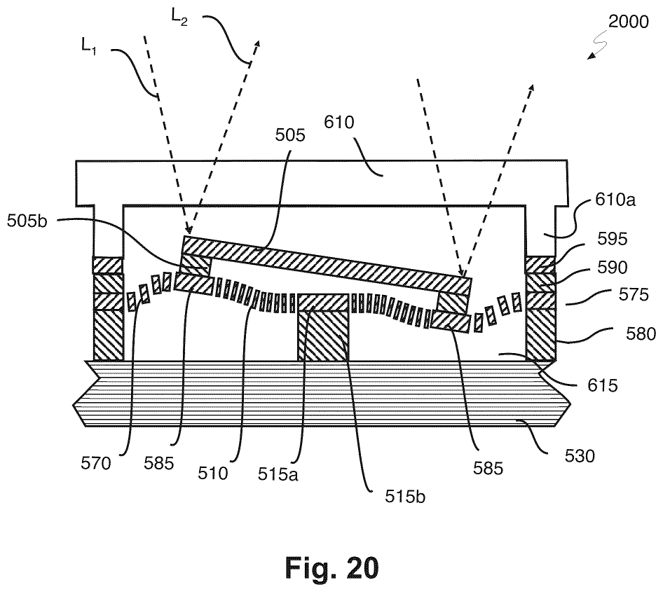

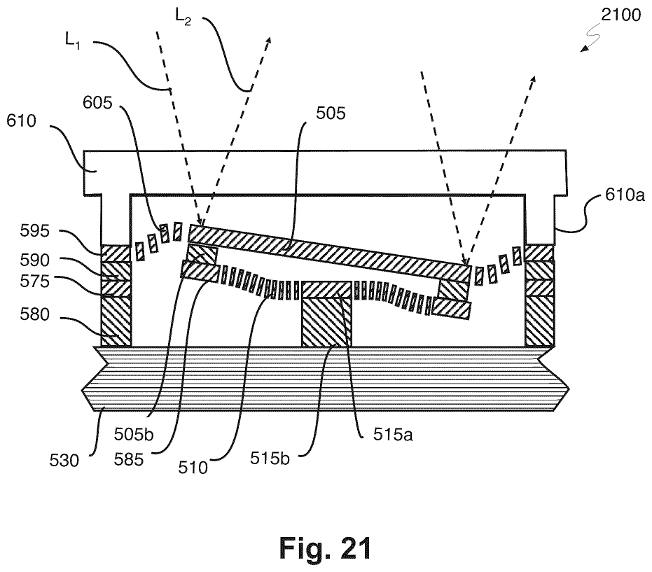

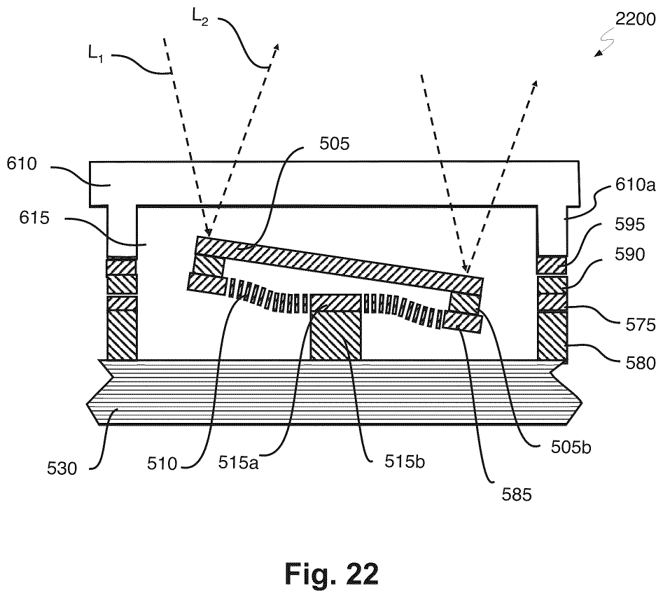

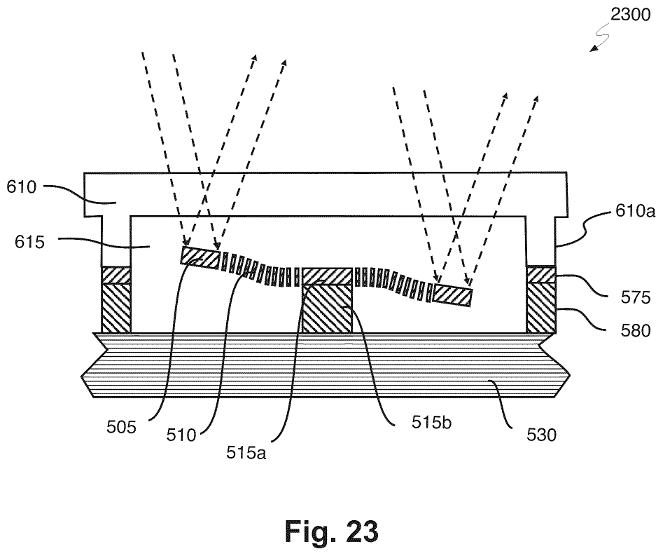

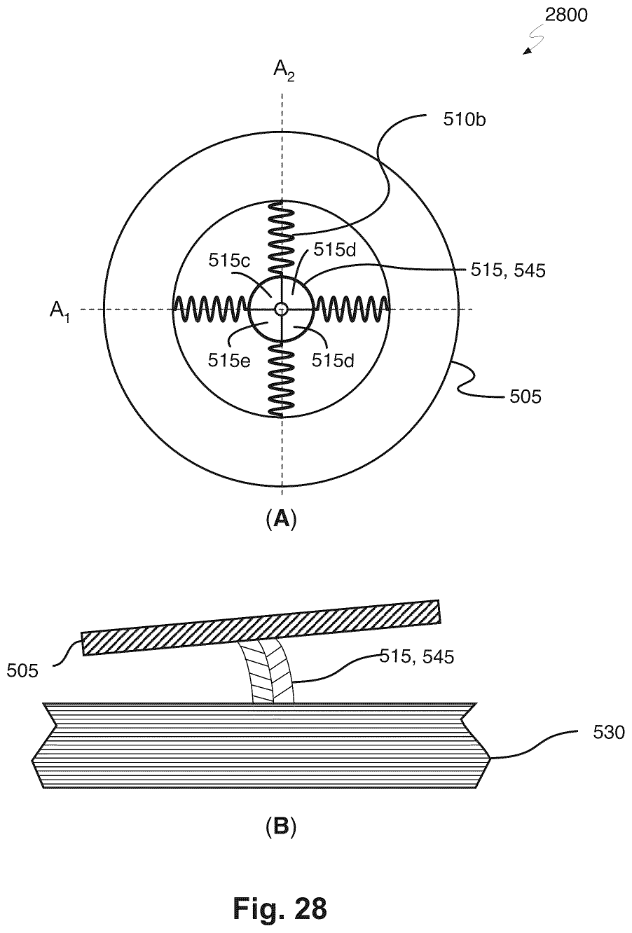

Various exemplary embodiments of microscanner architectures according to the invention will now be explained below with reference to FIGS. 5 to 28. Some of these figures each contain two sub-figures (A) and (B), wherein the respective sub-figure (A) represents a top view and the respective associated sub-figure (B) (except for FIG. 28) represents a cross-sectional view perpendicular to the image plane and along the axis A₁ of the embodiment shown in the respective figure. The actuators 545, which are regularly used to drive the respective microscanner, are only shown in some of the figures, in particular if their position or shape is particularly relevant to the design of the respective microscanner.

FIG. 5 shows a first exemplary embodiment 500 of a microscanner. The microscanner 500 has an annular mirror plate as a deflection element 505, which is suspended via—selected here as an example—N=4 (first) springs 510 on a centrally arranged post used as a spring support structure 515 and carried by a carrier substrate 530, which in particular has a higher torsional and bending stiffness than the springs 510. The spring support structure 515 can already represent a complete support structure for the deflection element 505. The post 515 has two different layers 515a and 515b, wherein the layer 515a is manufactured from the same substrate as the first springs 510 and the mirror plate 505. Each of the (first) springs 510 extends between an associated attachment point 520 (each marked by means of a diamond) on the spring support structure 515 on the one hand and an associated coupling point 525 (each marked by means of a small circular ring) on the inner edge of the annular deflection element 505. The circular interior 505c of the 505 deflexion element, defined by the circular ring of the deflexion element 505, represents a “recess” in the deflexion element 505 in the meaning of the invention. In particular, it can be designed as a continuous opening or only as a depression.

Each two of the springs 510 opposite to one another with respect to the spring support structure 515 form a pair of springs, which in particular defines the direction and the oscillation frequency and thus the scanning frequency of an assigned oscillation axis A₁ or A₂ of the deflection element 505. In the example shown in FIG. 5, the two pairs of springs are arranged orthogonally to one another, so that in the rest position of the deflection element 505, in which apart from gravity and the spring forces of the springs 510, no significant other forces act on the deflection element and it is at rest, an angle of, at least essentially, 90° occurs between each two adjacent springs. However, other arrangements of the springs 510 are also possible, in which different angles occur between adjacent springs instead.

For a better explanation of the microscanner 500, three exemplary points 535a to 535c, each located on the deflection element 505, are marked in the sub-figure (A) of FIG. 5 by means of solid black circles. The points 535a to 535c span an auxiliary plane H (cf. FIG. 5A for further explanation), which can in particular coincide with a surface of the deflection element 505 or, in FIG. 5, with the plane of the drawing. In this auxiliary plane H, the points 535a to 535c moreover span a triangular area D as a surface section on the auxiliary plane H by means of their respective straight connecting lines 540, each connecting two of the points. All attachment points 520 (or their perpendicular projections onto the auxiliary plane H) lie within this surface section D, so that the previously described central suspension of the deflection element 505 on the spring support structure 515 results. Another choice of three points 535a to 535c on the deflection element 505, which fulfill the above-mentioned condition, is also possible.

In particular, in the microscanner 500, the springs 510 (or their perpendicular projection onto the auxiliary plane H) extend here within the circular recess 505c in the deflection element 505, which defines its circular ring shape on the inside (or within their perpendicular projection onto the auxiliary plane H). While in FIG. 5 both the deflection element 505 and the post-shaped spring support structure 515 each have a rotational symmetry, here even circular symmetry, and the spring support structure 515 is also arranged centrally relative to the deflection element 505, so that the respective axes of symmetry of at least the deflection element 505 and the spring support structure 515 coincide, other variants without or with a different, in particular smaller number of such symmetries are also possible.

The further embodiments of a microscanner described below are derived from the microscanner 500 from FIG. 5 by addition or modification, so that hereinafter only these differences will be described in detail hereinafter as the focus, while otherwise reference will largely be made to the preceding description of FIG. 5. In the figures from FIG. 5 onwards, the same reference numerals are used throughout for the same or corresponding elements of the various embodiments illustrated in these figures, so that repetitive descriptions of identical or corresponding elements are usually unnecessary. As long as they are not mutually exclusive, two or more of the embodiments described below or their respective differentiating technical aspects (e.g., encapsulation, actuator arrangement, imaging optics, etc.) can also be combined.

FIG. 5A illustrates a schematic cross-sectional view of an embodiment related to the microscanner 500, in which the first springs 510, in particular their attachment points 520 on the spring support structure 515, are not in the auxiliary plane H spanned by the three points 535a, b, c on the deflection element 505. In the present example, a Y-shaped arrangement of the combination of spring support structure 515 and the first springs 510 results instead in cross section. However, the perpendicular projection P of the attachment points 520 onto the auxiliary plane H again lies in the area section D spanned by the points 535a, b, c in the auxiliary plane H, as shown in FIG. 5, sub-figure (A).

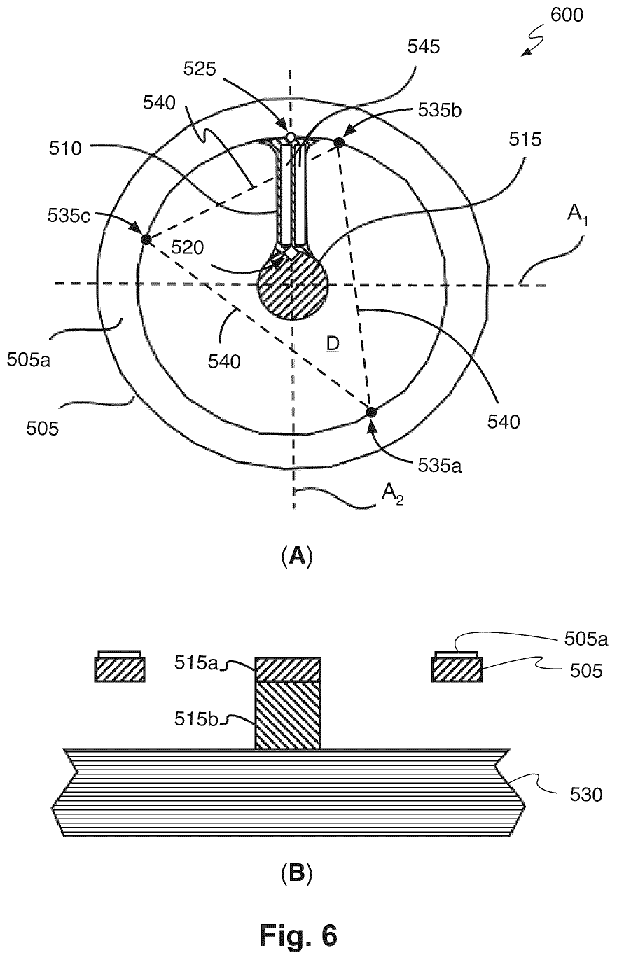

FIG. 6 illustrates a further embodiment 600 of a microscanner, in which, in contrast to microscanner 500 from FIG. 5, only a single (first) spring 510 is provided for suspending the deflection element 505 on the spring support structure 515 carried by a carrier substrate 530. The single spring 510 again extends between a attachment point 520 on the spring support structure 515, which has two stacked layers 515a and 515b, and a coupling point 525 on the inside of the annular deflection element 505. The deflection element 505 has, at least on one of its annular surfaces, an additional mirror layer 505a as a reflection surface, which can in particular be formed as a deposited metal layer, for example made of aluminum or chrome. The spring 510 acts primarily as a spiral spring with respect to the oscillation axis A₁ and primarily as a torsion spring with respect to the second oscillation axis A₂. An auxiliary plane H is again spanned by three points 535a to 535c and a triangular surface section D is spanned by the straight connecting lines 540 between the points 535a to 535c, in which the attachment point 520 or its projection onto the auxiliary surface H (see FIG. 5A) lies.

While no actuators for driving the oscillations of the deflection element were shown in FIG. 5, two strip-shaped piezo actuators 545, which are placed on the spring 510, are shown in FIG. 6. The spring 510 can be set into a two-dimensional oscillation with appropriate activation of the piezo actuators in order to offset simultaneous oscillations of the deflection element 505 on the one hand around the first oscillation axis A₁ and on the other hand around the second oscillation axis A₂ with respective assigned individual oscillation or scanning frequencies. This enables a Lissajous projection of an electromagnetic beam, in particular a light beam, incident on the deflection element 505, more precisely on its mirror surface 505a, into an observation field.

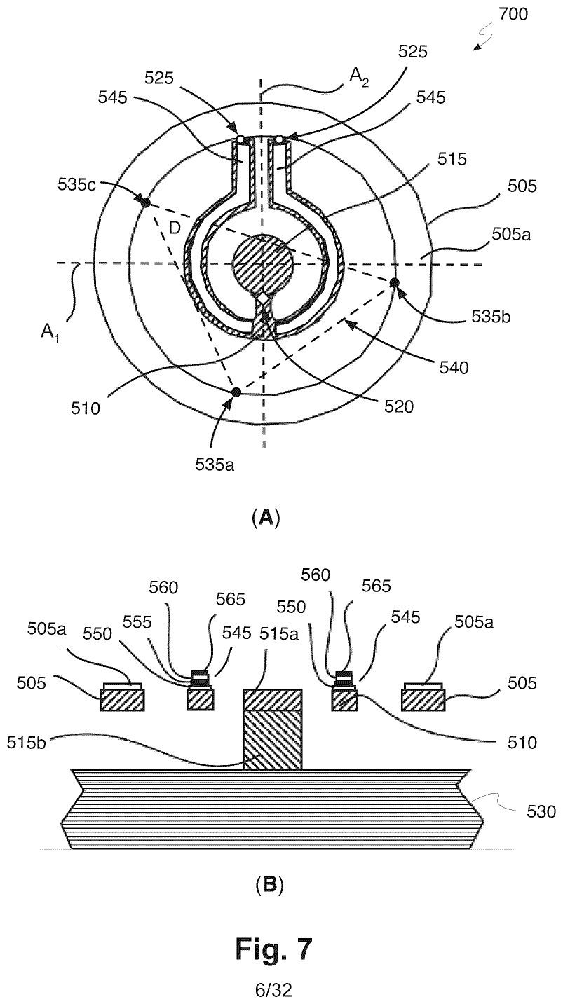

FIG. 7 shows a further embodiment 700 of a microscanner, which has a mirror suspension, in which the deflection element 505, which has a ring mirror 505, is suspended directed inwards on the spring support structure 515 using two spring legs, which are initially separate in some sections. Immediately before the two spring legs merge into the central post of the spring support structure 515, they combine to form a single (first) spring 510. The example particularly illustrates the possibility of being able to efficiently use the central area (recess) in the center of the deflection element 505 for the spring suspensions.

The possibility of being able to guide the springs around the central post 515 makes it possible in particular to implement relatively long and wide springs 510, which advantageously enable both high spring stiffness and therefore high resonance frequencies, and at the same time large deflections, which is very advantageous for many display solutions. In this example, the two separated spring legs are each occupied by a piezo bending actuator 545, so that the springs 510 and thus also the deflection element 505 can be excited to oscillate. Each piezo bending actuator 545 has a layer stack made of a piezoceramic layer 560 lying between two electrodes 555 and 565 and is fastened on the associated spring 510 by means of a suitable bonding material 550.

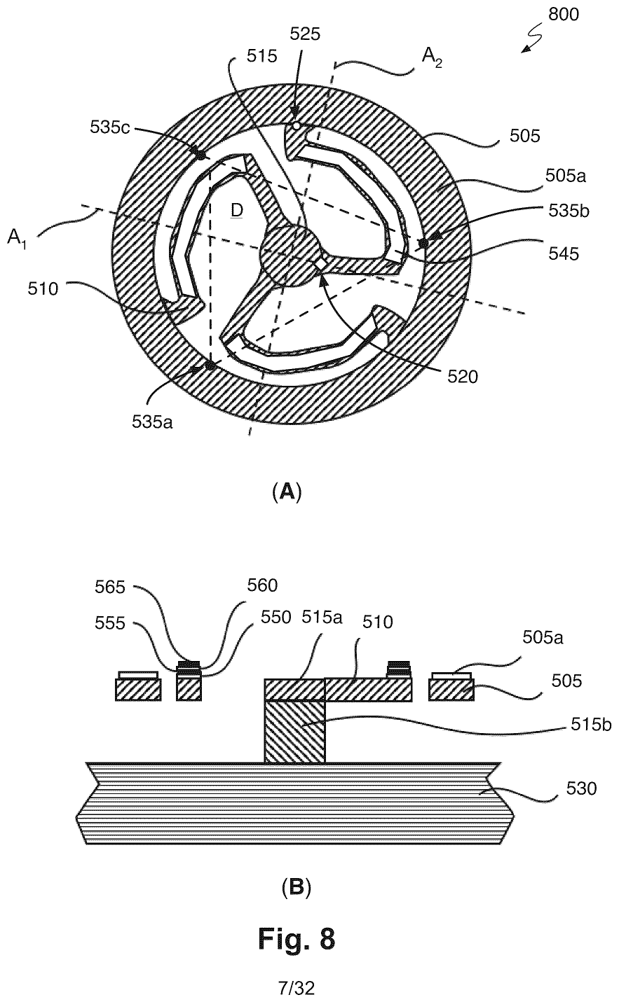

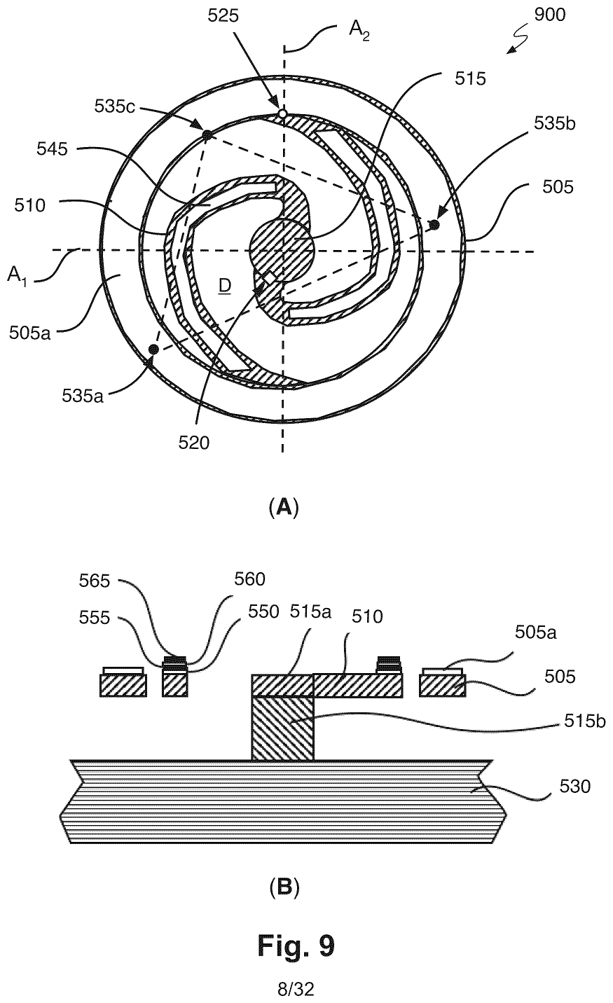

FIGS. 8 and 9 illustrate two further embodiments 800 and 900 of a microscanner, in which, in contrast to the microscanner 500 from FIG. 5, multiple (first) springs 510 arranged in a spiral shape are provided for the suspension of the deflection element 505 on the spring support structure 515 carried by the carrier substrate 530. In the microscanner 800 there is a three-leg suspension made up of three rotationally symmetrically arranged and similar (first) springs 510, whereas in the case of the microscanner 900 there is a two-leg suspension made up of only two rotationally symmetrically arranged similar (first) springs 510.

Both embodiments 800 and 900 are characterized by spring lengths that are significantly longer than the respective straight-line distance between the respective attachment points 520 and coupling points 525 of the springs 510. This in particular facilitates keeping the springs in their linear (Hook's) operating range even with large mirror deflections when the microscanner 800 or 900 is in operation. The microscanner 900 also has the advantage that the exact positions of the oscillation axes A₁ and A₂ can be easily determined in advance and they are essentially independent of the oscillation frequencies used.

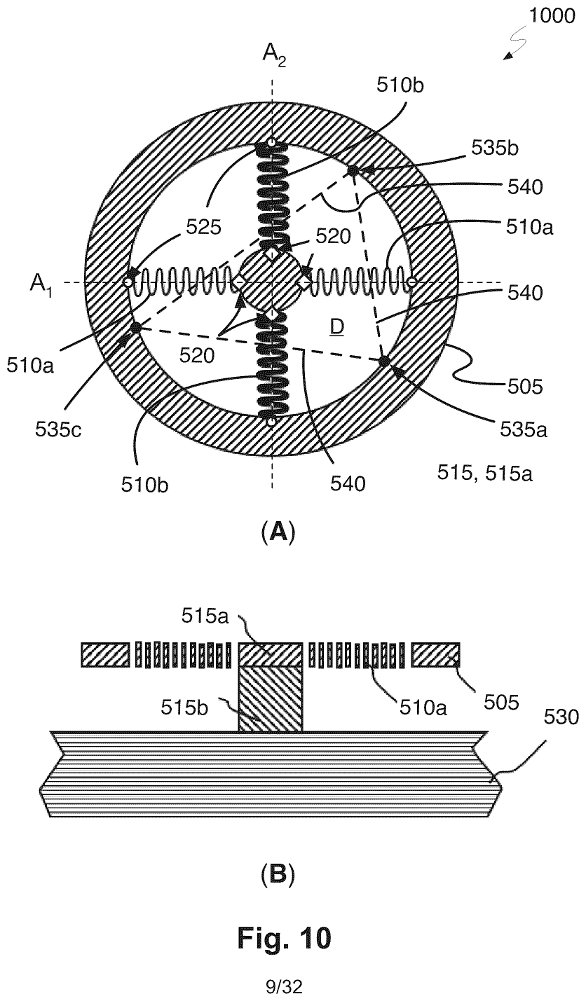

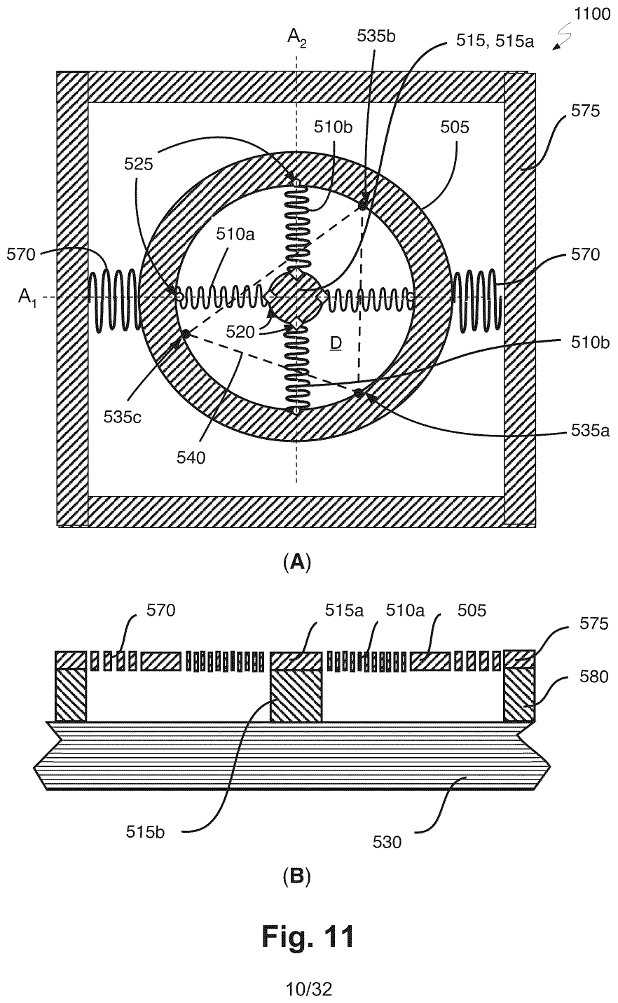

FIG. 10 shows a further embodiment 1000 of a microscanner, which largely corresponds to the microscanner 500 from FIG. 5, but differs from it in that one of the two pairs of springs, here for example the spring pair 510b, has a different spring stiffness than the other pair of springs 510a. The two springs of each pair of springs 510a and 510b, on the other hand, are preferably the same in terms of their spring stiffness, in particular overall. In this embodiment, it is particularly easy to define different oscillation or scanning frequencies for the two axes A₁ and A₂ by means of deliberate selection of the different spring stiffnesses, without the design of the scanner beyond the springs 510a or 510b necessarily having to be modified.

FIG. 11 shows a further embodiment 1100 of a microscanner, which arose from the microscanner 1000 from FIG. 10 in that a frame structure having a (first) rigid outer frame 575 is provided as an additional element of the support structure, on which the deflection element 505 is additionally suspended, in particular—as shown here—along an oscillation axis A₁, using second springs 570. The (first) outer frame 575 can in particular be supported by a support structure 580, which is manufactured from the same substrate as the layer 515b of the spring support structure 515. This embodiment 1100 allows in particular a further differentiation of the available spring stiffnesses and thus scanning frequencies. This is in particular relevant with regard to rectangular illumination of the observation field, where it is particularly important that a set frequency interval between the scanning frequencies of the two oscillation axes A₁ and A₂ is maintained during operation of the microscanner.

Compared to the microscanners known from the prior art having mirror suspensions exclusively on an outer frame, smaller constructions can be implemented for the microscanner 1100 despite the (first) outer frame 575 also present here, since the linearity requirements and requirements for high spring stiffness can already largely be implemented by the internal first springs 510. The second springs 570 can therefore be selected to be shorter and do not necessarily have to be always operated in the linear range in order to still enable reliable and high-frequency operation of the microscanner. Rather, the spring effects of the first springs 510a and the second springs 570 complement one another to form a combined spring effect, in particular when the springs 510a and 570, as shown here, extend essentially along the same direction, in particular the oscillation axis, so that the resulting effective spring properties continue to be predominantly determined by the internal first springs 510a, but are additionally influenced by the spring properties of the external second springs 570. This allows, in particular, an increase in design freedom compared to a solution having exclusively first springs 510a, b.

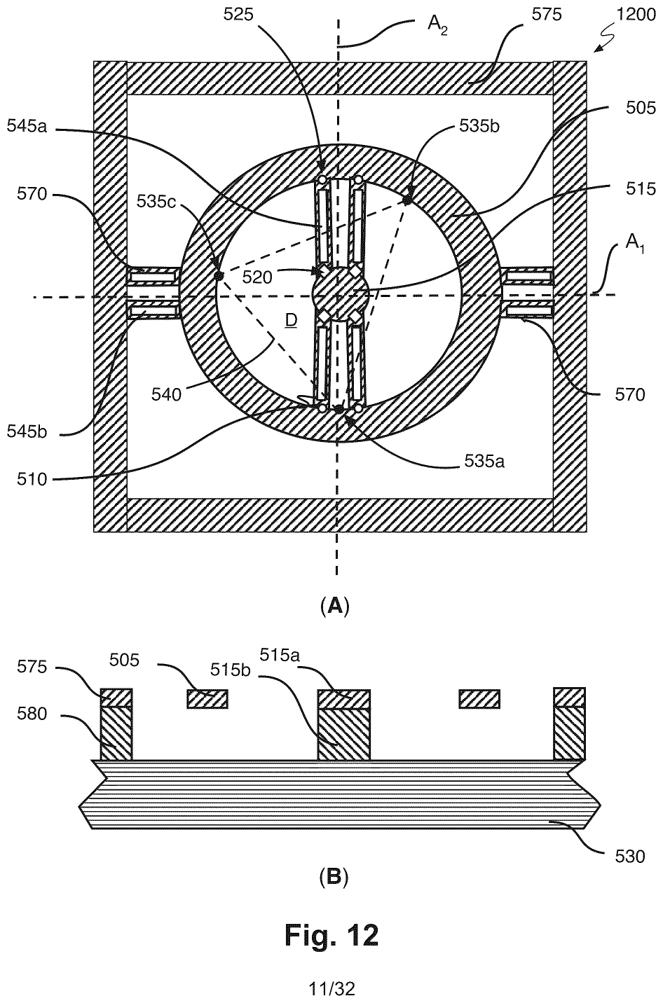

FIG. 12 shows a further embodiment 1200 of a microscanner, which arose from the microscanner 1100 from FIG. 11 in that, on the one hand, instead of the first springs 510a and 510b of the microscanner 1100 arranged in the shape of a cross, N=4 first springs 510 are now provided, which are arranged in two pairs of springs extending adjacent to one another, wherein the pairs of springs extend essentially along a first of the two oscillation axes, here the axis A₂. In a similar way, the second springs 570 of the microscanner 1100 in the microscanner 1200 are replaced by two pairs of springs which extend adjacent to one another at least essentially along the other of the two oscillation axes, here the axis A₁. The pairs of springs made up of the first springs 510 thus extend, at least approximately, orthogonally to the pairs of springs made up of the second springs 570.

Instead of the arrangement of the spring pairs shown here, in particular non-parallel arrangements of the spring pairs of the first springs 510 or the spring pairs of the second springs 570 are also conceivable, wherein the respective arrangement is preferably designed in such a way that the respective associated oscillation axis represents an axis of symmetry for the arrangement of the first springs 510 or the second springs 570.

In the case of microscanner 1200, it is possible in particularly, as illustrated, to provide separate actuators or actuator groups 545a and 545b for driving each of the two oscillation axes A₁ and A₂, so that each oscillation axis can be activated individually particularly easily.

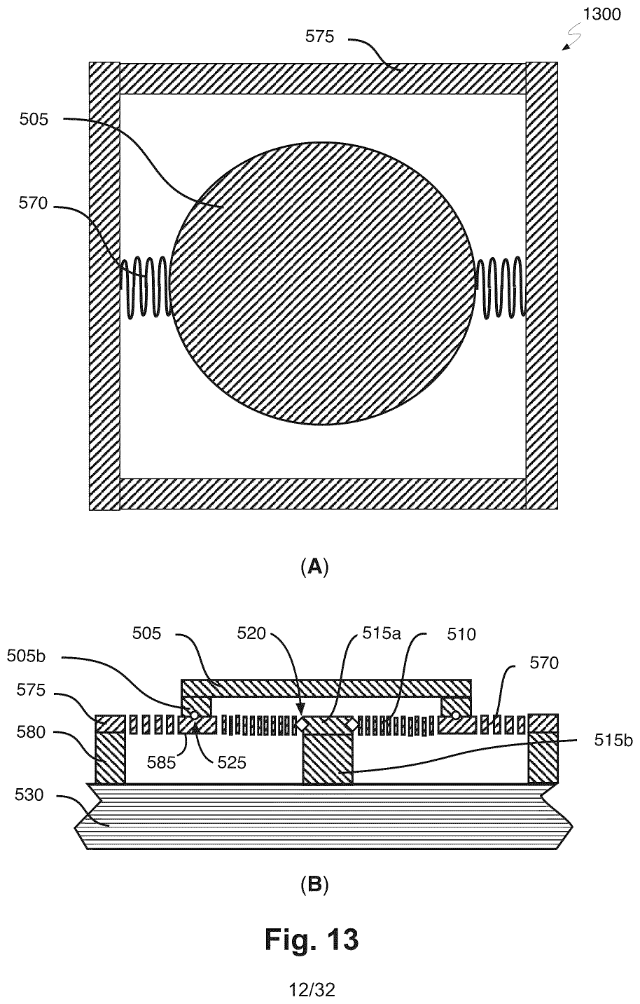

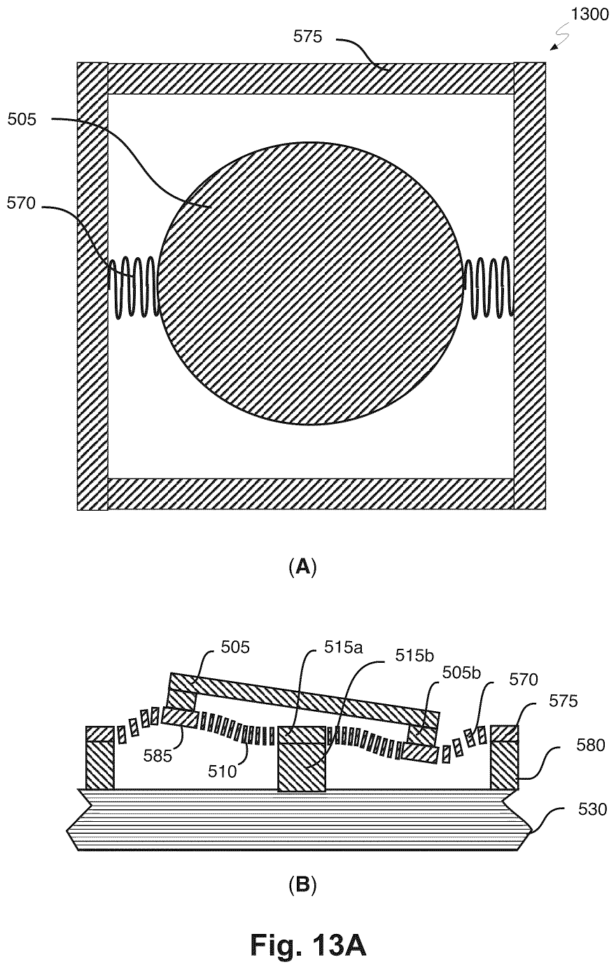

FIG. 13 shows a further embodiment 1300 of a microscanner, which arose from the microscanner 1100 from FIG. 11 in that instead of an annular deflection element 505, which in the microscanner 1100 is arranged in the same layer as the first springs 510 and the second springs 570, a separate mirror plate is provided in a further layer parallel thereto as a deflection element 515. The mirror plate 515 can in particular have a circular surface shape or another shape without recesses. It is preferably separated from the first springs 510 by at least one intermediate layer 505b, so that the first springs 510 have enough space available for their oscillations without striking the mirror plate 505. The intermediate layer 505b can be viewed in particular as a component of the deflection element 515 and rests on a fastening section 585 provided between the first springs 510 and the second springs 570.

The microscanner 1300 is characterized in particular by a further compact form factor, in which the size ratio of its reflection surface to the total surface of the microscanner can be designed particularly favorably. The different layers of this microscanner architecture can in particular each be provided by a semiconductor wafer or another substrate, wherein the different, structured substrates can then be connected to the microscanner architecture, in particular by means of one or more bond connections.

FIG. 13A shows the same embodiment 1300 of a microscanner again, but, in particular in sub-figure (B), during its operation, so that the different spring deflections that occur can be seen. In particular, it can be seen that, according to preferred variants, the spring stiffness of the first springs 510 can be higher than that of the second springs 570.

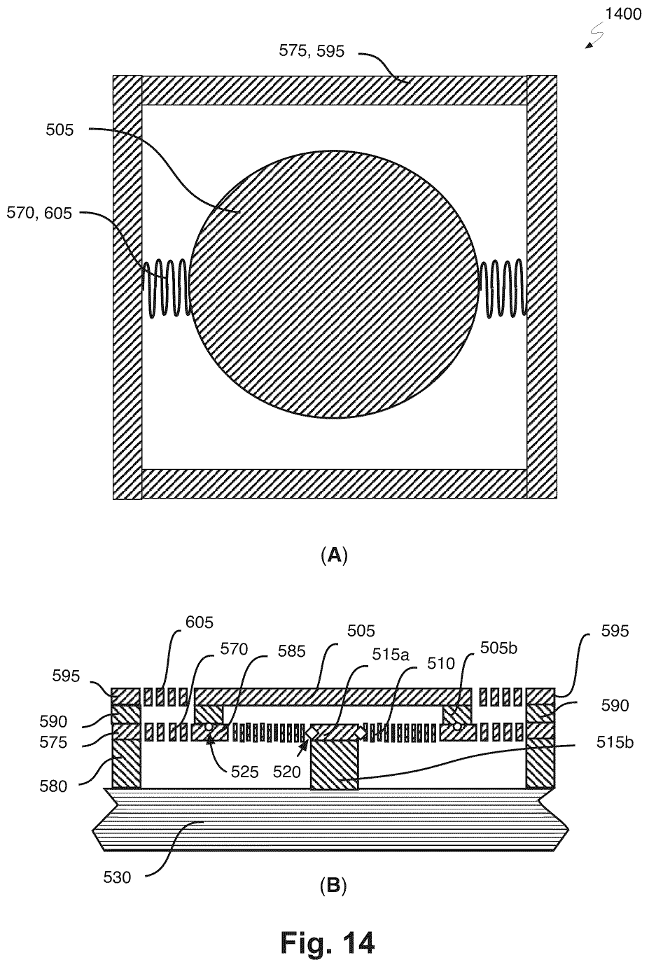

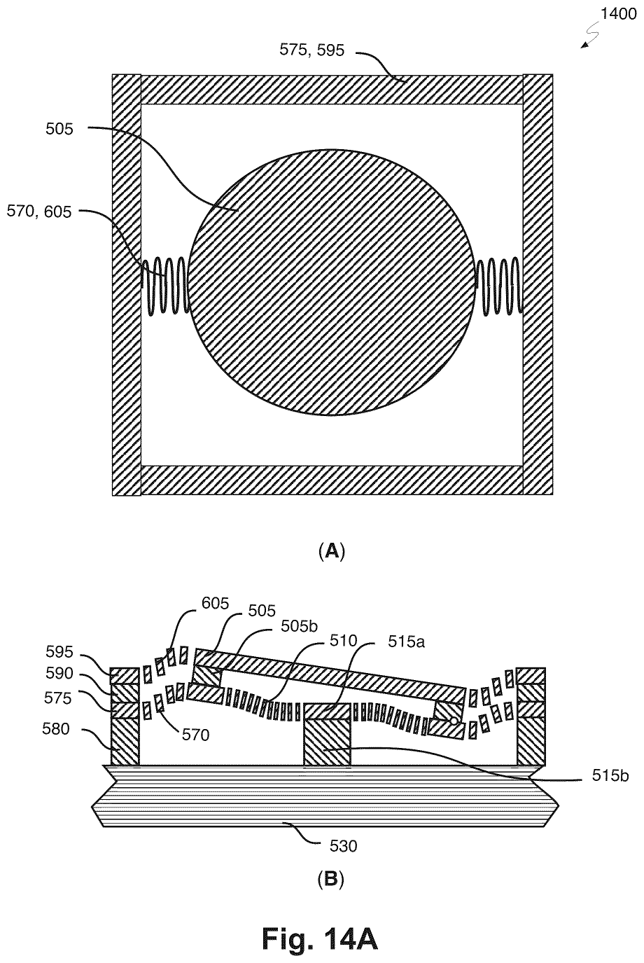

FIG. 14 shows a further embodiment 1400 of a microscanner, which arose from the microscanner 1300 from FIG. 13 in that additional third springs 605 are provided, which extend in the same layer as the deflection or mirror plate 505 from this to a further (second) outer frame 595 of the frame structure, which can be fastened in particular via an intermediate element 590 in an intermediate layer on the (first) outer frame 575. The third springs 605 preferably extend parallel to the second springs 570, at least in the rest position of the microscanner 1400, although this does not necessarily have to be the case.

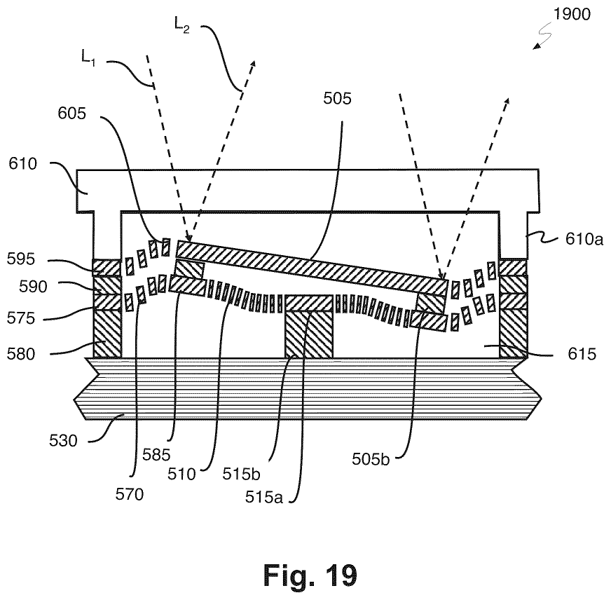

The addition of the third springs 605 in particular enables an even further increase in the overall spring stiffness of the suspension of the deflection element 505 caused by the combination of the first, second, and third springs, especially in the linear spring range, and also enables even greater design freedom in the design of the microscanner. This can be used in particular to generate a wide variety of effective overall spring stiffnesses by the combination of the different springs 510, 570, and 605 and thus in particular to achieve the high scanning frequencies desired for many applications, generally above at least 20 kHz, often up to 100 kHz and above, for the microscanner 1400. In some variants—not shown here—the second springs 570 can also be omitted in favor of the third springs 605 (cf. FIG. 19).

FIG. 14A shows the same embodiment 1400 of a microscanner again, but, in particular in sub-figure (B), during its operation, so that the different spring deflections that occur can be seen. In particular, it can be seen that, according to preferred variants, the spring stiffness of the first springs 510 can be higher than that of the second springs 570 and the third springs 605.

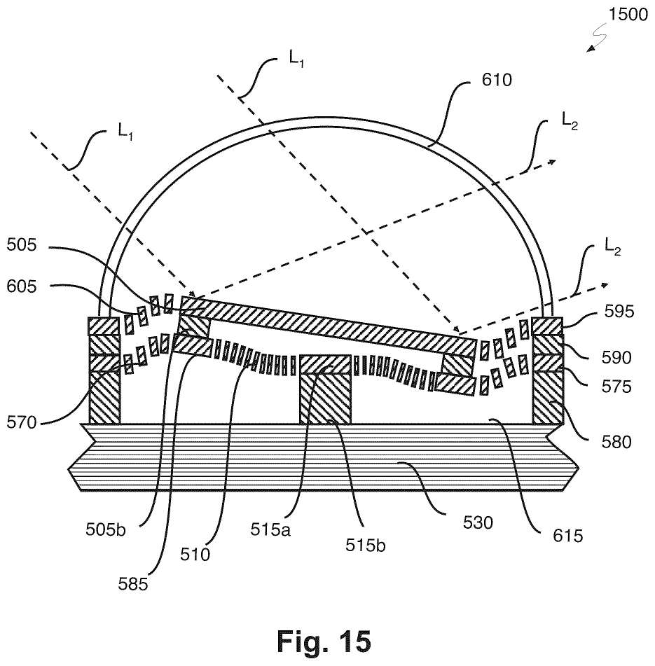

FIG. 15 shows another embodiment 1500 of a microscanner, which arose from the microscanner 1400 from FIG. 14 by additionally creating a hermetically sealed encapsulation by placing a dome-shaped or cupola-shaped capsule part 610 (“capsule section”) on the second outer frame 595. The encapsulation encloses an evacuated spatial area 615 in which the deflection element 505, which is resiliently suspended from the support structure, is located and can carry out its oscillations with almost no air friction due to the evacuation. The capsule section 610 is largely transparent, at least in some sections, to incident electromagnetic radiation in a wavelength range corresponding to the desired working range of the microscanner 1500 and can in particular comprise a glass material or be formed entirely therefrom. Thus, incident electromagnetic rays L₁ can pass through the capsule section 610 onto the deflection element 505 essentially undisturbed and with only slight deflections due to the cupola shape of the capsule section 610 and are converted there in the sense of an optical image by reflection on the deflection element 505 into corresponding emitted rays L₂, which in turn can leave the microscanner 1500 through the capsule section 610 in the direction of the desired observation field.

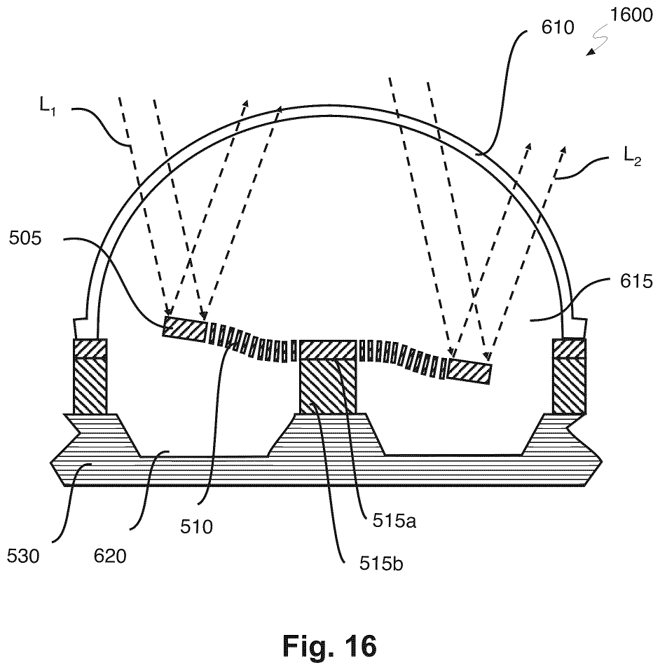

FIG. 16 shows a further embodiment 1600 of a microscanner, which arose from the microscanner 500 from FIG. 5 in that a hermetic encapsulation on the basis of a capsule section 610 was added and moreover cavities 620 were created in the carrier substrate 530, which enable the deflection element 505 to execute particularly large oscillation amplitudes (deflections) in the course of the oscillations without striking the carrier substrate 530. For this purpose, the capsule section 610 can in particular be placed on a base which is formed as a layer stack from the same layers as the layer stack made up of, on the one hand, the layer 515b of the spring support structure 515 and, on the other hand, the layer which contains the layer section 515a of the spring support structure 515, the deflection element 505, and the first springs 510.

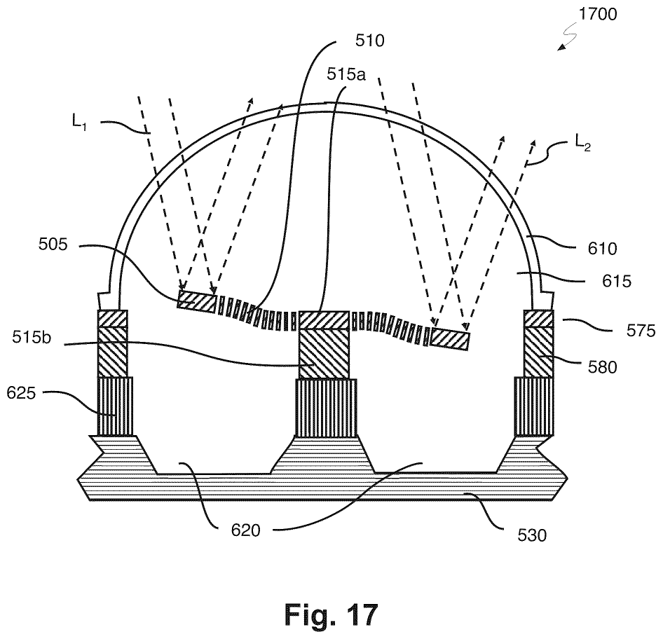

FIG. 17 shows a further embodiment 1700 of a microscanner, which arose from the microscanner 1600 from FIG. 16 in that—in particular with the purpose of further increasing the free space available for the oscillations of the deflection element in the spatial area 615 below the capsule section 610—another intermediate layer 625 was created. The intermediate layer 625 can in particular be arranged between the carrier substrate 530 and the layer 515b of the spring support element 515 or the support structure 580.

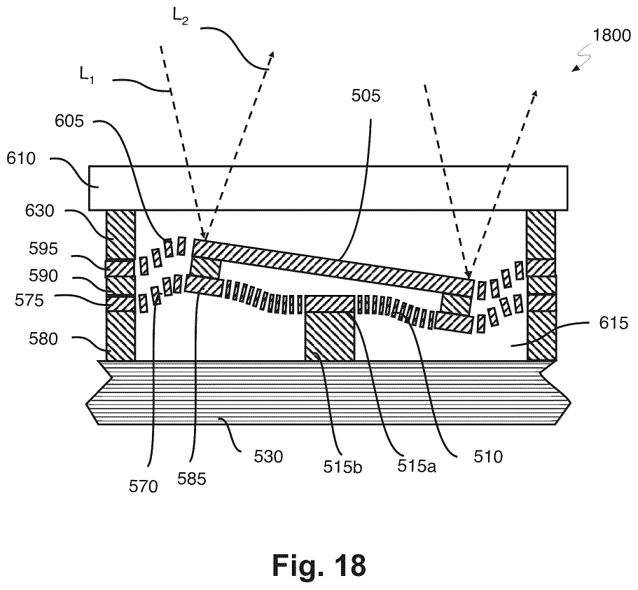

Instead of a dome-shaped encapsulation, other capsule shapes are also possible, in particular planar covers. Various embodiments 1800 to 2300 of a microscanner having a planar cover as a capsule section 610 are illustrated in FIGS. 18 to 23 in combination with various ones of the previously explained embodiments 500 to 1400.

In the embodiment 1800 from FIG. 18, the planar cover 610 consists solely of a planar plate, such as a glass plate. In order to create sufficient freedom of movement for the oscillation of the deflection element 505, a further spacer layer 630 is provided between the cover 610 and the further outer frame 595.

Further embodiments 1900 to 2300 from FIGS. 19 to 23 having different suspensions differ from the embodiment 1800 in particular in that instead of the spacer layer 630, which can therefore be omitted, the capsule section 610 itself has a corresponding support ring 610a in addition to a planar cover plate, in particular in one-piece formation with the planar cover plate. In the case of a circular cover plate, the support ring 610a can in particular have a circular ring shape. The cross section thus results in a “U” shape of the 610 capsule section, including its support ring 610a.

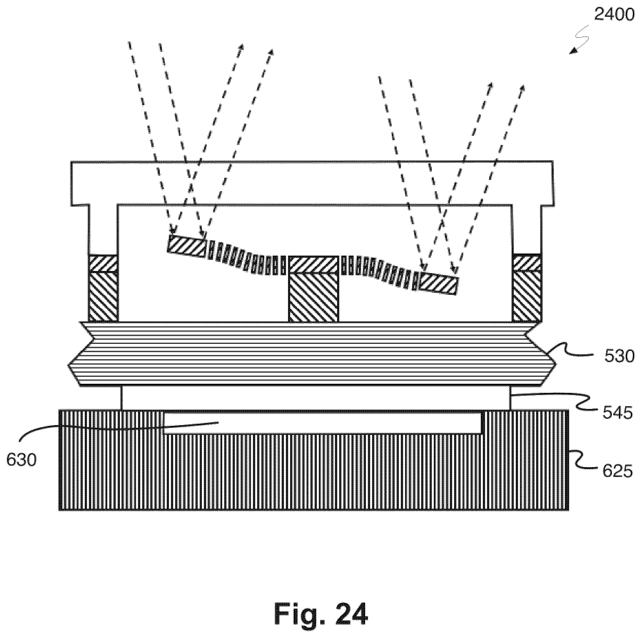

Further embodiments 2400 to 2600 from FIGS. 24 to 26 differ from the embodiment 2300 in particular in that on the main side of the carrier substrate 530 facing away (in the figures: lower) from the deflection element 505 an, in particular plate-shaped, actuator (such as a piezo actuator) 545 for driving the oscillations of the deflection element 505 is arranged, which in turn is preferably fastened at least at points on an additional base substrate 625. The actuator 545 can in particular be activated simultaneously using the respective resonance frequencies of the two oscillation axes A₁ and A₂ in order to operate the microscanner as a Lissajous scanner. This arrangement has the advantage in particular that the actuator can be arranged separately from the oscillating parts, in particular the springs and the spring suspension, and in the case of encapsulated microscanners even outside the encapsulated spatial area 615, which in particular facilitates its electrical contacting for signal and power supply. The oscillating parts, in particular the deflection element 505 and the springs of the microscanner and their support structure, can thus be designed to be purely passive.

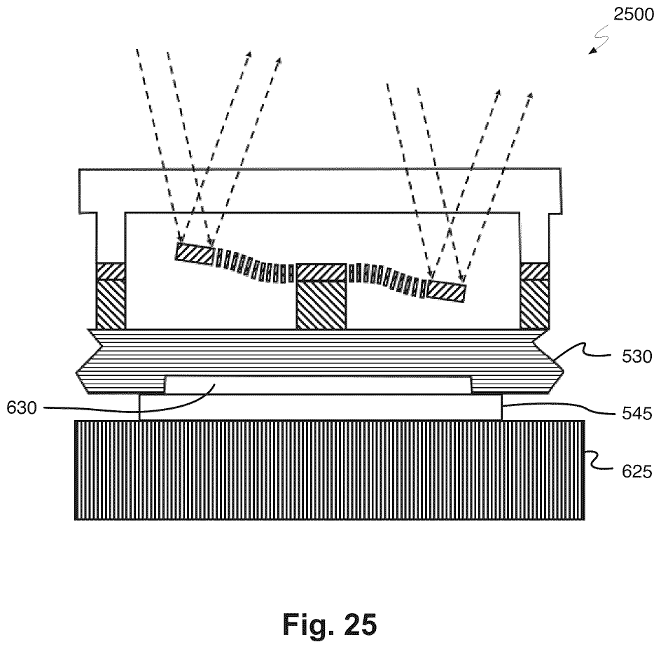

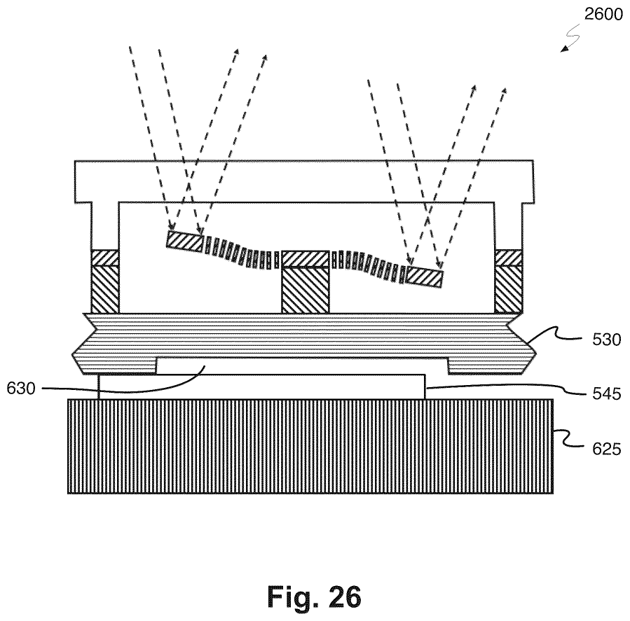

On at least one main side of the actuator 545, it is surrounded at least in some sections by a cavity 630, which offers it a free space to carry out its movements, in particular vibrations or oscillations. In the case of the embodiment 2400 from FIG. 24, this cavity 630 is formed as a recess in the base substrate 625 and lies between the carrier substrate 530 and the actuator 545. In the embodiment 2500 from FIG. 25, however, the cavity 630 is formed as a recess in the main side of the carrier substrate 530 facing toward the actuator 545. In both embodiments 2400 and 2500, the actuator 545 is fixed on both sides of the cavity 630 by the layer stack between the substrates 530 and 625. In contrast, in the embodiment 2600 from FIG. 26, which is derived from the embodiment 2500, an end region of the actuator 545 is not enclosed by the substrates 530 and 625, so that during its operation oscillations in the form of tilting movements may be transmitted to the microscanner structure lying above it having the oscillating parts.

The embodiments 2400 to 2600, which are illustrated here as an example with the microscanner architecture according to the embodiment 2300, can also easily be combined with other embodiments, such as those that do not have any further actuators for driving the deflection element 505, and those that which have an outer frame 575 or 595 or a dome-shaped or diffently-shaped encapsulation.

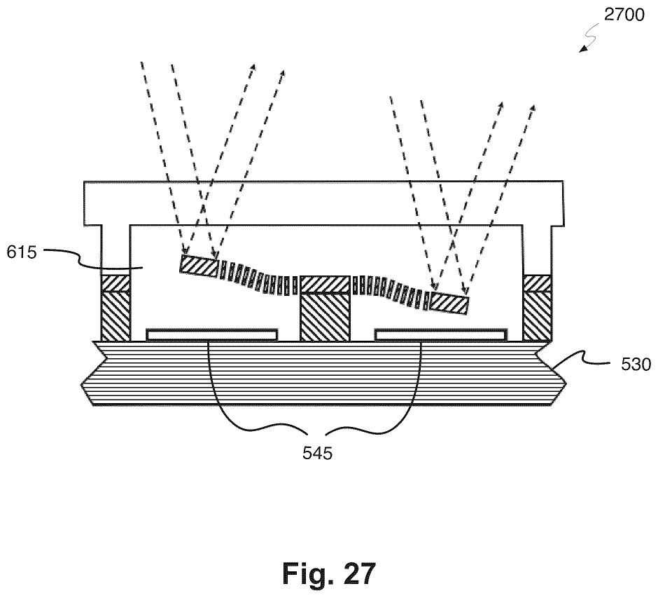

Another embodiment 2700 from FIG. 27 differs from the embodiment 2300 in particular in that one or more actuators 545 for driving the microscanner 2700 are arranged on the side of the carrier substrate 530 facing toward the deflection element 605 and thus, if an encapsulation is present, within the encapsulated spatial area 615. This arrangement can be used in particular to use the actuator(s) 545 at the same time as a sensor system or part thereof (in particular as an electrode for a capacitive measurement), wherein the sensor system can be provided in particular for determining a current position of the deflection element 505.

FIG. 28 shows a further embodiment 2800 of a microscanner, which arose from the microscanner 500 from FIG. 5 in that the spring support structure 515 is also designed as a drive device 545 for the microscanner 2800. For this purpose, the spring support structure 515, which may in particular be post-shaped, is also designed as an actuator, in particular as a piezo actuator. The spring support structure 515 can in particular have four piezo actuators, which, viewed in cross section in relation to the longitudinal axis of the spring support structure or the post, form four quadrant-shaped piezo segments 515c to 525f. By suitable activation of these four piezo actuators, the deflection of the deflection element 505 with respect to its two oscillation axes A₁ and A₂ can be controlled and, in particular, a resonant or, overall, a double-resonant oscillation of the deflection element 505 can be achieved. Due to this “dual-use” function of the spring support structure, the provision of additional actuators can be avoided and in particular fastening actuators on the springs can be omitted, so that particularly compact and robust constructions can be implemented in this way.

The production of a microscanner according to any one of these embodiments can in particular be carried out in such a way that the spring support structure 515 is placed on the carrier substrate 530, in particular a semiconductor substrate such as a Si substrate, and fixed there. This can be done in particular by means of gluing or soldering. The deflection element can then be attached to the fixed spring support structure 515, which can in particular again be done by means of gluing or soldering.

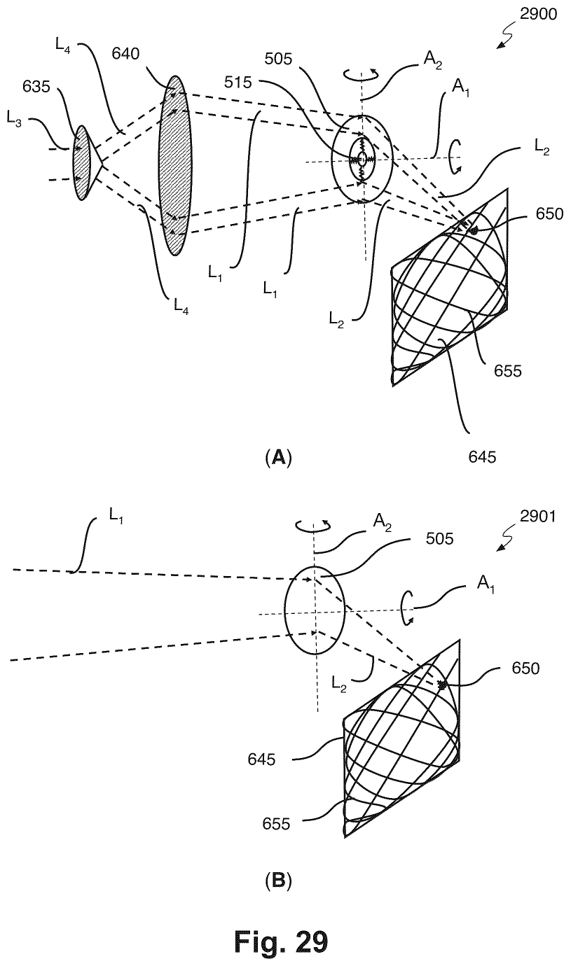

FIG. 29 shows in its sub-figure (A) an embodiment 2900 of a microscanner, which can be used advantageously in particular in connection with annular deflection units 505, in particular annular mirrors, and has special optics for forming an annular beam cross section for the electromagnetic radiation L₁ incident on the deflection element 505. In contrast, sub-figure (B) shows a further embodiment 2901 without such optics, which is suitable in particular in conjunction with full-surface (recess-free) deflection units 505, for example those according to the embodiments 1800 to 2200.

In the embodiment 2901 according to sub-figure (B), the incident electromagnetic radiation L₁ is incident on the deflection element 505, where it is reflected and projected as an exiting beam L₂ into an observation field, which in the present example contains a projection surface 645, such as a projection screen, house wall, or a street surface. When the beam L₂ is incident on the projection surface, it preferably has a substantially punctiform cross section or a cross section corresponding to a small circular surface (for example as a laser beam) and thus generates a substantially punctiform intensity maximum (light spot) 650 (in FIG. 29 shown oversized as a black circle). Due to the first and second oscillations of the deflection element 505 when it is operated as a Lissajous scanner, a Lissajous FIG. 655 is created on the projection surface 645 by the corresponding movement of the light spot, which, with suitable selection of the scanning frequencies of the two oscillation axes A₁ and A₂, illuminates a selected section of the observation or projection field and thus the projection surface 645.

In the embodiment 2900 according to sub-figure (A), in contrast, the above-mentioned special optics, which in particular have an axicon 635 and a converging lens 640, are arranged in the beam path. During operation of this arrangement, incident electromagnetic radiation L₃, for example a laser beam having a circular cross section, is first directed onto the axicon 635, which splits the beam into a beam La having an annular, in particular circular ring-shaped, beam cross section. A splitting into multiple concentric rings (in the beam cross section) is also possible (similar to or like Bessel beams). The beam La is imaged on the converging lens 640, which in turn images it as a light beam L₁ having an annular radiation cross section on the deflection element 505 of the respective microscanner, which in the present example has a circular ring-shaped deflection or mirror plate. The deflection element 505 in turn images the incident light beam L₁ by reflection by means of an emerging light beam L₂ as a Lissajous projection into the observation field or onto the projection surface 645.

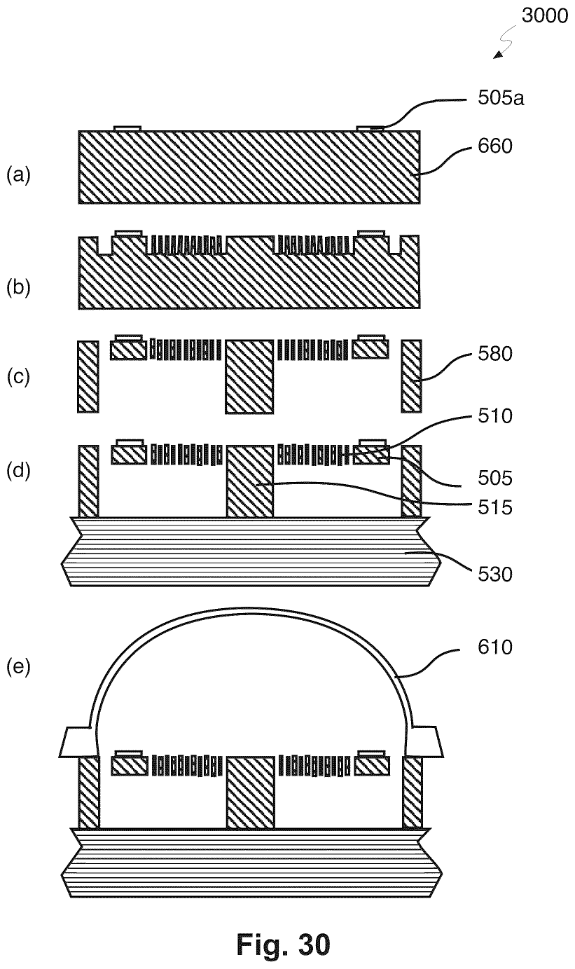

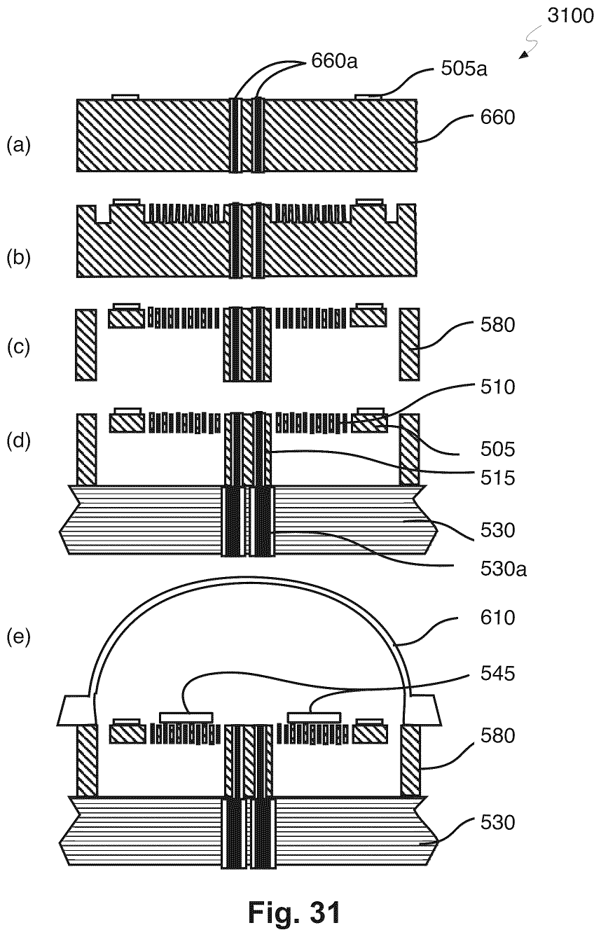

Two exemplary embodiments 3000 and 3100 of a method according to the invention for producing a microscanner, in particular a microscanner with encapsulation, will now be explained below with reference to FIGS. 30 and 31.

In the embodiment 3000 of the method shown in FIG. 30, in a first process, as illustrated in sub-FIG. 30(a), a plate-shaped substrate 660, in particular a semiconductor substrate such as a silicon substrate, is provided and a reflection layer (mirror layer) 505a is applied on a main side of the substrate on the at least one surface section, on which a reflection surface of the deflection element 505 is to be created. The latter can be done in particular by means of deposition (for example by sputtering followed by polishing) of a suitable material, in particular metal, such as aluminum.

Then, in a further process, as illustrated in sub-FIG. 30(b), the substrate 660 is structured from one of its main sides, preferably from the main side on which the reflection layer was previously formed. As a result, the deflection element 505, the support structure, in particular the spring support structure 515, and the spring device, in particular the first springs 510, are formed at least in some sections. This can be done in particular by means of one or more etching processes in conjunction with lithography to form a plurality of trenches in the substrate 660 for section-by-section separation of the individual microscanner components from one another.

In a further process, from the opposite main side, as illustrated in sub-FIG. 30 (c), the elements of the microscanner that have already been partially formed by means of the structuring, in particular the deflection element 505, the first springs 510, and the spring support structure 515, are selectively placed on the substrate 660 exposed or fully structured. “Selectively” here means that the substrate 660 is not removed or thinned over the entire surface during the exposing process, but rather the exposing takes place deliberately (and therefore selectively) on those sections of the substrate 660 that have to be removed in order to fully expose the deflection element 505 and its spring suspension.

This is followed by a further process in which, as illustrated in sub-FIG. 30 (d), the previously created structure is applied to a carrier substrate 530 and fixed there, in particular by means of one or more suitable connection processes. In principle, anodic, eutectic, or direct bonding processes or thermocompression processes are particularly suitable as connection processes for this purpose.

Now, in a still further process, as illustrated in sub-FIG. 30 (e), a capsule section 610 is added to produce a hermetic encapsulation. This is preferably done in such a way that a gas pressure (for example air pressure) that is lower than atmospheric pressure or even a vacuum is formed in the encapsulated interior 615, so that gas friction effects (for example air friction effects) can be at least reduced or even essentially avoided during the subsequent operation of the microscanner.

The embodiment 3100 of the method shown in FIG. 31 represents a refinement of the method 3000 from FIG. 30, in which additional electrical connections are provided for electrical components, in particular actuators 545 or sensors, provided on the spring support structure 515, the spring suspension (in particular the first springs 510), or the deflection element 505. For this purpose, as additionally illustrated in sub-FIG. 31 (a), an electrical connection 660a extending through the substrate 635 is formed at suitable locations between the two opposite main sides of the substrate 660, for example by means of suitable etching processes and subsequent filling of the resulting cavities with electrically conductive material.

In the case of a semiconductor substrate, in particular made of silicon, in particular methods known from semiconductor process technology for producing so-called “through silicon vias” (TSV) can be used here. The electrical connections 660a preferably extend through a section of the substrate 635, which is formed into the spring support structure 515 as part of the method 3000. The processes according to sub-FIGS. 31 (b) and 31 (c) correspond to those from sub-FIGS. 30 (b) and 30 (c) of the method 2900.

Furthermore, in the method 3000, as additionally illustrated in sub-FIG. 31 (d), electrically conductive channels 530a corresponding to the electrical connections 660a are formed in the carrier substrate 530 in order to ensure the electrical connection of the actuators 545 or sensors to the outside of the microscanner architecture, in particular to the outside of the carrier substrate 530, and to provide a connection option there. If the substrate 530 is of the same type of material as the substrate 660, the same or related processes can typically be used to produce the electrical channels 530a. Otherwise, for example if the substrate 530 is designed as a printed circuit board (PCB), other correspondingly suitable, known processes can be used to produce the electrical channels 530a extending through the substrate 530.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and its legal equivalents.

### LIST OF REFERENCE SIGNS

100 known microscanner architecture having gimbal suspension
105 deflection element, in particular mirror plate
110 comb drive remote from the axis for oscillation axis A₁
115 comb drive close to the axis for oscillation axis A₁
120 internal torsion spring
125 movable frame
130 external torsion spring
135 chip frame
140 external comb drive for oscillation axis A₂
200 known microscanner architecture of the three-legged “MiniFaros” type
205 deflection element, in particular mirror plate
210 bow spring
215 inner end of the bow spring, coupling point on the deflection element
outer end of the bow spring, attachment point on the chip frame 220
225 chip frame
230 comb drive
235 slotted free spaces
300 known microscanner architecture of the three-legged “MiniFaros” type
305 deflection element, in particular mirror plate
310 bow spring
315 inner end of the bow spring, coupling point on the deflection element
320 outer end of the bow spring, attachment point on the chip frame
325 chip frame
330 comb drive
335 slotted free space
400 known microscanner architecture of the two-legged “MiniFaros” type
405 deflection element, in particular mirror plate
410 bow spring
415 inner end of the bow spring, coupling point on the deflection element
420 outer end of the bow spring, attachment point on the chip frame
425 chip frame
500 embodiment of a microscanner
501 variant of embodiment 500
505 deflection element, in particular mirror plate
505a reflection or mirror layer on the deflection element 505
505b intermediate layer of the deflection element
505c recess of the deflection element
510 first spring
510a first spring having lower spring stiffness
510b first spring having higher spring stiffness
515 spring support structure, in particular post
515a first layer of the spring support structure 515
515b second layer of the spring support structure 515
515c-f piezo segments
520 inner end of a first spring, attachment point on the spring support structure
525 outer end of a first spring, coupling point on the deflection element 505
530 carrier substrate
530a electrical channel
535a, b, c points on the deflection element 505, which span a surface section on an auxiliary plane
540 straight connecting lines between each two points 535a-c
545 actuator, in particular piezo actuator, for driving the microscanner
550 bond material or bond layer
555 first electrode of the piezo actuator 545
560 piezo ceramic layer of the piezo actuator 545
565 second electrode of the piezo actuator 545
570 second spring
575 (first) outer frame of the frame structure
580 support structure
585 fastening section, intermediate body
590 intermediate element
595 further outer frame of the frame structure
605 third spring
610 capsule section, or encapsulation
610a support ring
615 encapsulated spatial area or interior
620 cavity in the carrier substrate 530
625 intermediate layer
630 (further) spacer layer
635 Axicon
640 converging lens
645 projection surface
650 intensity maximum (light point)
655 Lissajous FIG.
660 (starting) substrate, in particular semiconductor substrate
660a electrical connection, in particular through-silicon via (TSV)
600, . . . , 2900 further embodiments of a microscanner
3000, 3100 embodiments of a method for producing a microscanner
A₁, A₂ oscillation axes
D (triangular) surface section on the auxiliary plane H
L₁, . . . , L₄ electromagnetic beams, in particular laser beams
H auxiliary plane
P perpendicular projection

What is claimed is:

1. A microscanner for projecting electromagnetic radiation onto an observation field, wherein the microscanner comprises:
a deflection element for deflecting an incident electromagnetic beam;
a support structure; and
a spring device comprising one or more springs, by means of which the deflection element is suspended on the support structure in an oscillating manner in such a way that it can simultaneously carry out a first rotational oscillation around a first oscillation axis and a second rotational oscillation around a second oscillation axis orthogonal thereto relative to the support structure, in order to be able to effectuate a Lissajous projection in an observation field by deflection of an electromagnetic beam incident on the deflection element during the simultaneous oscillations;
wherein the support structure has a spring support structure and the spring device has a number N of first springs, wherein N≥1 and each of the N first springs is attached to at least one assigned attachment point on the spring support structure, is coupled to the deflection element at at least one assigned coupling point, and extends between this attachment point and this coupling point; and
wherein there are three points on the deflection element, which, in its rest position define a Euclidean auxiliary plane and, within the auxiliary plane, span a surface or straight line section enclosed by the connecting line between the three points, on which each of these attachment points or their respective perpendicular projection onto the auxiliary plane lies.

2. The microscanner according to claim 1, wherein the deflection element has rotational symmetry with respect to an axis of symmetry in its rest position and is arranged such that the axis of symmetry extends through the spatial area spanned by the spring support structure.

3. The microscanner according to claim 1, wherein the N first springs are each attached to the support structure exclusively on the spring support structure and the deflection element is suspended exclusively on these first springs.

4. The microscanner according to claim 1, wherein the deflection element has a deflection plate with a recess formed therein.

5. (canceled)

6. (canceled)

7. The microscanner according to claim 1, wherein at least one of the N first springs is shaped such that in its rest position its effective spring length between the deflection element and the spring support structure is greater than minimum occurring distance between one of its coupling points on the deflection element, on the one hand, and one of its attachment points on the spring support structure, on the other hand.

8. The microscanner according to claim 1, wherein the spring device has exactly N=2 first springs, which together form a two-leg suspension of the deflection element on the spring support structure.

9. The microscanner according to claim 1, wherein the spring device has N=4 first springs, wherein these four first springs together provide a cross-shaped suspension of the deflection element on the spring support structure.

10. The microscanner according to claim 9, wherein two at a time of the four first springs form a respective spring pair of springs of the same spring stiffness, while the respective spring stiffnesses for the first springs of the two spring pairs differ.

11. The microscanner according to claim 1, wherein the support structure furthermore has a frame structure which surrounds the deflection element at least on two sides and is fixed with respect to the first and second rotational oscillations of the deflection element, on which the deflection element is additionally suspended by means of a number M of second springs, wherein M≥1.

12. (canceled)

13. The microscanner according to claim 1, wherein N≥2 and the deflection element extends between the respective coupling points of the N first springs in such a way that it at least partially bridges the spring support structure.

14. The microscanner according to claim 13, wherein the deflection element has a substrate designed as a deflection plate for deflecting the incident electromagnetic beam, which is connected by means of at least one bond connection to one or more of the first springs or to an intermediate body arranged between one or more of the first springs on the one hand and the deflection plate on the other hand.

15. The microscanner according to claim 13, wherein the spring device furthermore has a number K of third springs, wherein K≥1;
wherein each third spring is coupled on the one hand to the respective coupling point of an assigned first spring or possibly the intermediate body and on the other hand to the frame structure.

16. The microscanner according to claim 1, further comprising an encapsulation by means of which at least the deflection element and the springs of the spring device are encapsulated hermetically sealed in such a way that the deflection element is suspended on the spring device in a manner capable of carrying out the oscillations; wherein the encapsulation has a capsule section bridging the deflection element, through which the radiation to be deflected can be radiated into the spatial area encapsulated by the encapsulation and, after it is deflected at the deflection element, can be emitted therefrom again.

17. (canceled)

18. (canceled)

19. A beam deflection system according to claim 1, wherein the quality factor of the microscanner with respect to at least one of the two oscillations is at least 1000.

20. The microscanner according to claim 1, furthermore comprising:
a carrier substrate supporting the spring support structure; and
an actuator for driving the first oscillation and/or the second oscillation of the deflection element;
wherein the actuator is mechanically coupled to the carrier substrate in order to act on it mechanically during operation of the microscanner and thereby indirectly effectuate a driving effect on the deflection element for driving its first and/or second oscillations, at least via the spring support structure and the first springs.

21. (canceled)

22. (canceled)

23. The microscanner according to claim 1, wherein one or more actuators or sensors are provided on the spring support structure or the spring device, which are connected to one or more signal or power supply lines, which overall extend at least in some sections through one or more openings provided in the spring support structure.

24. The microscanner according to claim 1, wherein the microscanner is configured in such a way that the following applies to the frequency ratio of the oscillation frequency f₁ with respect to the faster of the two oscillation axes to the resonance frequency f₂ with respect to slower of the two the oscillation axes: f₁/f₂=F+v, wherein F is a natural number (F=1,2,3, . . . ) and the following applies to the detuning v:v=(f₁−f₂)/f₂ with (f₁−f₂)<200 Hz, wherein v is not an integer.

25. The microscanner according to claim 1, comprising an actuator system having one or more actuators for driving the first and second oscillations, wherein the actuator system is configured so that it can set the deflection element into a double-resonant oscillation with respect to the first and second oscillation axes.

26. (canceled)

27. A method for producing a microscanner according to claim 1, wherein the method comprises:
providing a plate-shaped substrate having two opposing main surfaces;
structuring the substrate from a first of the main surfaces to the at least partial formation of the deflection element, the support structure, and the spring device;
selectively, at least partially exposing the deflection element and the spring device, each formed by means of the structuring, from the other main surface; and
fastening the microscanner arrangement resulting from the exposure on a carrier substrate.

28. The method according to claim 27, furthermore comprising at least one of the following processes:
applying a reflection layer to a surface section provided for forming the deflection element on a main side of the substrate;
hermetically encapsulating the microscanner arrangement attached to the carrier substrate by means of an encapsulation;
bonding at least two adjacent substrates within a layer stack used to construct the microscanner by means of an anodic, eutectic, or direct bonding method or a thermocompression method;
creating one or more actuators or sensors on the spring support structure or the spring device and creating one or more signal or power supply lines which, at least in some sections, extend through one or more openings provided in the spring support structure and to which the actuators or sensors are connected.
